(19) United States
(12) Patent Application Publication
(10) Pub. No.: US 2003/0081786 A1
(43) Pub. Date: May 1, 2003

(54) Key management apparatus

(76) Inventors: Toshihisa Nakano, Neyagawa (JP); Masato Yamamichi, Kadoma (JP); Yuichi Futa, Osaka (JP); Kaoru Yokota, Ashiya (JP); Natsume Matsuzaki, Minou (JP); Makoto Tatebayashi, Takarazuka (JP)

Correspondence Address: WENDEROTH, LIND & PONACK, L.L.P., 2033 K STREET N. W., SUITE 800, WASHINGTON, DC, 20006-1021, US

(21) Appl. No.: 10/277,747

(22) Filed: Oct. 23, 2002

(30) Foreign Application Priority Data
Oct. 26, 2001 (JP) 2001-329862

(51) Int. Cl. H04L 9/00

(52) U.S. Cl. 380/277

(57) ABSTRACT

A digital work protection system composed of (a) user apparatuses that are recording apparatuses and/or reproduction apparatuses for recording or reproducing digital contents such as movies, (b) a recording medium, and (c) a key management apparatus that manages the assignment of device keys to the user apparatuses using a tree structure. The key management apparatus always keeps some leaves with which no user apparatus is not correlated in the tree structure, generates new leaves that are connected from the leaves and belong to a new layer, and assigns new user apparatuses to the newly generated leaves.

### BACKGROUND OF THE INVENTION

(1) Field of the Invention

The present invention relates to a technique for recording a digital work on a recording medium and reproducing the digital work from the recording medium, and in particular to a technique for managing key information for content encryption/decryption to protect the digital work.

(2) Description of the Related Art

Accompanying developments in recent years in techniques such as digital processing, storing, and communication, services that provide digital content such as movies to users by way of sale or rental of large-capacity recording media have become widespread. In addition, systems in which digitized content is broadcast, received by a reception apparatus, stored on a recording medium such as a recordable optical disc, and then reproduced by a reproduction apparatus are becoming common.

In providing such a service or system, it is necessary to protect the copyright of the content, and perform reproduction, copying and so on under limitations consented to by the copyright holder, so that the content is not used illegally.

Generally, a digital work is protected in the following way from illegal copying for which the copyright holder has not consented. A recording apparatus encrypts the digital content with an encryption key, and records the encrypted content on a disc. Only a reproduction apparatus that has a decryption key corresponding to the encryption key is able to decrypt the encrypted content. An agreement for copyright protection are determined by the manufacturer of the recording apparatus and the reproduction apparatus etc. in conjunction with the copyright holder, and the manufacturer obtains the encryption key or the decryption key (hereinafter simply referred to as “the key”), on the condition that the manufacturer adheres to the agreement. The manufacturer must manage the obtained key stringently so that it is not divulged to a third party.

However, even when the manufacturer manages the key stringently, there is a possibility that a third party will obtain the key illegally. Once the key has been exposed by the third party, the third party may circulate the key, manufacture a recording and/or reproduction apparatus that uses the content illegally, or create a computer program that uses the content illegally and distribute the computer program via the Internet, without regard for the agreement consented to by the manufacturer and the copyright holder. It is desirable that in such a case the copyright holder is able to make content that is provided after the key has been exposed unusable with the exposed key.

The following is the simplest method that responds to this desire.

The key management organization (hereinafter simply referred to as “the organization”) has a set of keys that consists of a plurality of device keys and a plurality of media keys. The organization assigns one of the device keys and a device key identification number respectively to each of a plurality of recording apparatuses and a plurality of reproduction apparatuses, and then provides each recording apparatus and reproduction apparatus with the respective device key and device key identification number. In addition, the organization assigns one media key to a recording medium. Next, the organization encrypts the media key, using each of the device keys assigned to the recording apparatuses and the reproduction apparatuses, to generate encrypted media keys, and stores a list of the encrypted media keys corresponding to all the device keys, and the key identification numbers on the recording medium as key information.

When the recording medium is loaded into a recording apparatus or a reproduction apparatus, the apparatus extracts the encrypted media key corresponding to the key identification number assigned to the apparatus itself, from the key information in the recording medium, and decrypts the extracted encrypted media key, with use of the device key that is assigned to the apparatus itself, to generate the media key. Next, the recording apparatus encrypts content using the obtained media key, and records the resulting encrypted content on the recording medium. On the other hand, the reproduction apparatus decrypts encrypted content in the same way, using the obtained media key.

In this way, if a recording apparatus or a reproduction apparatus has a legitimately assigned device key, it is always able to obtain the same media key from the recording medium, thus maintaining compatibility between devices.

Here, suppose that the device key of a particular recording apparatus or reproduction apparatus has been exposed. When storing key information on a new recording medium after the device key has been exposed, the organization creates key information that does not include the exposed device key, and stores the created key information on the recording medium. In this way, an illegitimate apparatus that knows the exposed device key is unable to obtain the correct media key from the key information, because an encrypted media key encrypted using the exposed device key is not included in the key information stored in the recording medium. As a result, the illegitimate apparatus is unable to use the content illegally. For example, if the illegitimate apparatus is a recording apparatus, encrypted content recorded using that recording apparatus is not encrypted using the correct key, therefore the encrypted content cannot be decrypted using a legitimate reproduction apparatus. Furthermore, if the illegitimate apparatus is a reproduction apparatus, that reproduction apparatus is unable to obtain the correct media key, and is therefore unable to correctly decrypt encrypted content that has been recording using a legitimate recording apparatus. In this way, an exposed key can be revoked.

However, a defect in this simple method is that the size of the data of the key information is unrealistically large when there is a great number of apparatuses. For example, suppose that a particular type of digital device becomes widespread throughout the world, and billions of the particular device exist in the world. If the encryption algorithm used in generating the above-described encrypted content is the American standard encryption triple DES encryption, the length of one media key including padding will be 16 bytes. Consequently, the size of an encrypted media key will also be 16 bytes. Furthermore, if a four-byte value is used as the key identification number, the size of the key information will be 20 bytes*one billion apparatuses 20 billion bytes=20 giga bytes. This large value is unrealistic considering the capacity of current recordable optical discs.

In this kind of system it is a condition that the size of key information recorded on a recording medium be very small compared to the capacity of the recording medium.

One example of a system that meets this condition is a digital work protection key management method that uses a tree structure, disclosed in Document 1 “Digital Content Hogo-you Kagi Kanri Houshiki (Key Management Method for Protecting Digital Content)”, Nakano, Omori and Tatebayashi, Symposium on Cryptography and Information Security 2002, SCIS2001, 5A-5, January 2001.

Before describing the method disclosed in Document 1, a brief description is given of a tree structure.

In terms of form, the tree structure is a finite set T that is composed of at least one node, and is defined as meeting the following conditions.

(a) Only one node is designated as a root of the tree structure.

(b) Other nodes (excluding the root) are divided into sets T₁, . . . , Tₘ that do not have m (m≧0) common parts. Each Tᵢ (i=1, . . . , m) is a further tree structure whose height is “1” less than T. The tree structures T₁, . . . , Tₘ are subtrees of the root. Furthermore, the numbers of the levels (layers) in the tree structure T are defined in the following way. The root of T is level 0. Taking an example of a subtree Tⱼ that is a subtree of the root T, the level of the root Tⱼ is one greater than T. The following describes the digital work protection key management method that uses a tree structure disclosed in Document 1.

In this key management method, the organization constructs, as one example, a binary tree structure having four layers, and generates a number of keys that is equal to the number of nodes in the constructed tree structure. Each generated device key is assigned to a node in the tree structure. The organization corresponds each player (hereinafter “player” refers to the above-described reproduction apparatuses) with a leaf in the tree structure, and distributes one set of device keys to each player that is corresponded one-to-one with one of the leaves. The set consists of a plurality of device keys that are assigned to the nodes on the path from the corresponding leaf through to the root. In this way, a different device key set is distributed to each-player.

Here, when a device key set that has been assigned to one player is exposed, the organization deletes the nodes to which the device keys included in the exposed device key set are assigned. Then, the organization specifies the keys that are common to the greatest numbers of players, among the players whose device keys have not been exposed, as the next device keys to be used.

Document 1 shows that according to this method key information of approximately 3 MB will suffice if an arbitrary 10,000 of the billion players are to be revoked.

However, although it satisfies the condition that the size of the key information to be recorded on a recording medium is far smaller than the capacity of the recording medium, the above-described digital work protection key management method limits the total number of apparatuses in the system. This is because recording or reproduction apparatuses are assigned to leaves in a tree structure after the tree structure has been constructed. Accordingly, after the tree structure is constructed and the system comes into service, it is impossible to add a recording or reproduction apparatus to the system.

### SUMMARY OF THE INVENTION

It is therefore the object of the present invention to provide a digital work protection system that can limitlessly include additional recording apparatuses and/or reproduction apparatuses, allowing the newly added recording apparatuses and/or reproduction apparatuses to be compatible with already-existing recording and/or reproduction apparatuses, a key management apparatus, a user apparatus, a key management method, a key management program, and a recording medium storing the key management program. It should be noted here that being compatible means that a content recorded by a newly added recording apparatus on a recording medium can be reproduced by an already-existing reproduction apparatus, and that a content recorded by an already-existing recording apparatus on a recording medium can be reproduced by a newly added reproduction apparatus.

The above object is fulfilled by a digital work protection system including a key management apparatus and a user apparatus, the key management apparatus generating and correlating device keys with nodes in a tree structure and assigning the user apparatus to the device keys, the key management apparatus comprising: a determining unit operable to determine whether to add new leaves to the tree structure based on the number of leaves to which no user apparatus has been assigned; an extending unit operable to, if the determining unit determines to add, generate new leaves to extend from one of the leaves to which no user apparatus has been assigned; a user apparatus assigning unit operable to assign a user apparatus to one of the newly generated leaves; a device key generating unit operable to generate and correlate new device keys with nodes with which no device key has been correlated, among all nodes from the one of the newly generated leaves to a root inclusive; and a device key assigning unit operable to assign, to the user apparatus, device keys corresponding to the all nodes existing from the one of the newly generated leaves to the root inclusive, wherein the user apparatus either encrypts a content using one of the assigned device keys and writes the encrypted content onto a recording medium or reads an encrypted content from the recording medium and decrypts the read content using the one of the assigned device keys.

With the above-stated construction, the key management apparatus generates a new leaf to extend from an existent leaf in a tree structure, and assigns a user apparatus to device keys corresponding to the newly generated leaf. This enables the system to include an additional user apparatus by generating a new leaf if the system is requested to have an additional user apparatus after the system has come into service.

The above object is also fulfilled by a key management apparatus for generating and correlating device keys with nodes in a tree structure and assigning a user apparatus to the device keys, comprising: a determining unit operable to determine whether to add new leaves to the tree structure based on the number of leaves to which no user apparatus has been assigned; an extending unit operable to, if the determining unit determines to add, generate new leaves to extend from one of the leaves to which no user apparatus has been assigned; a user apparatus assigning unit operable to assign a user apparatus to one of the newly generated leaves; a device key generating unit operable to generate and correlate new device keys with nodes with which no device key has been correlated, among all nodes existing from the one of the newly generated leaves to a root inclusive; and a device key assigning unit operable to assign, to the user apparatus, device keys corresponding to the all nodes existing from the one of the newly generated leaves to the root inclusive.

With the above-stated construction, the key management apparatus generates a new leaf to extend from an existent leaf in a tree structure, correlates a user apparatus with the newly generated leaf, and assigns to the user apparatus all device keys corresponding to the nodes existing from the newly generated leaf to the root inclusive. This enables the system to include an additional user apparatus by generating a new leaf and correlating a user apparatus with the new leaf if the system is requested to have an additional user apparatus. Also, the set of device keys assigned to the user apparatus is unique to the user apparatus since the set of device keys consists of all device keys corresponding to the nodes existing from the newly generated leaf to the root inclusive. Accordingly, the user apparatus can be revoked.

The above object is also fulfilled by a key management apparatus for generating and correlating device keys with nodes in a tree structure and assigning a plurality of user apparatuses to the device keys, comprising: a device key storage unit operable to store in advance the tree structure and device keys that have been assigned to user apparatuses correlated with some leaves in the tree structure; a determining unit operable to determine whether to add new leaves to the tree structure based on the number of leaves to which no user apparatus has been assigned; an extending unit operable to, if the determining unit determines to add, generate new leaves to extend from one of the leaves to which no user apparatus has been assigned; a user apparatus assigning unit operable to assign a user apparatus to one of the newly generated leaves; a device key generating unit operable to generate and correlate new device keys with nodes with which no device key has been correlated, among all nodes existing from the one of the newly generated leaves to a root inclusive; and a device key assigning unit operable to assign, to the user apparatus, device keys corresponding to the all nodes existing from the one of the newly generated leaves to the root inclusive.

With the above-stated construction, the key management apparatus always has one or more leaves with which no user apparatus has not been correlated in a tree structure. This enables the system to include an additional user apparatus by generating a new leaf and correlating a user apparatus with the new leaf. In principle, the system can have additional user apparatuses limitlessly by correlating them with newly generated leaves. Also, the set of device keys assigned to the user apparatus is unique to the user apparatus since the set of device keys consists of all device keys corresponding to the nodes existing from the newly generated leaf to the root inclusive. Accordingly, the user apparatus can be revoked.

In the above key management apparatus, the determining unit may include: a counting unit operable to refer to the tree structure stored in the device key storage unit and count leaves to which no user apparatus is assigned; and a comparison unit operable to compare the counted number of leaves with a threshold value, wherein the determining unit determines to add new leaves to the tree structure if the counted number of leaves is equal to or smaller than the threshold value.

With the above-stated construction, the key management apparatus always has one or more leaves with which no user apparatus has not been correlated in a tree structure since the apparatus counts leaves to which no user apparatus is assigned and compares the counted number of leaves with a threshold value. This enables the apparatus to generate a new leaf to extend from an existent leaf as necessary.

In the above key management apparatus, the device key generating unit may further generate and correlate new device keys with all roots of subtrees that are generated when the nodes existing from the leaf to the root inclusive are deleted from the tree structure, the key management apparatus further comprising: an encrypted media key generating unit operable to generate encrypted media keys by encrypting media keys using all device keys generated by the device key generating unit on a one-to-one basis; and an encrypted media key writing unit operable to write the generated encrypted media keys onto a recording medium.

With the above-stated construction, if a user apparatus correlated with a leaf is revoked, the key management apparatus can generate an encrypted media key by encrypting a media key using device keys corresponding to the root of a subtree, and write the generated encrypted media key onto a recording medium. This enables a new user apparatus that is correlated with a newly generated leaf after the above user apparatus is revoked to be compatible with other user apparatuses to which device keys have already been assigned.

In the above key management apparatus, the comparison unit may store the threshold value in advance and compare the counted number of leaves with the threshold value.

With the above-stated construction, the key management apparatus can determine whether to add new leaves to the tree structure more easily since the apparatus holds the threshold value in advance and is not necessary to set the threshold value each time it performs the determination process.

In the above key management apparatus, the device key storage unit may store the same number of pieces of node information as there are nodes in the tree structure, the pieces of node information being linked to each other in the same manner as the nodes in the tree structure, each piece of node information including node ID information for identifying a certain node, a device key corresponding to the certain node, and user apparatus ID information for identifying a user apparatus corresponding to the certain node, the extending unit generates a new piece of node information that contains only node ID information identifying a new leaf, the new piece of node information linking to a piece of node information containing node ID information that identifies a leaf to which no user apparatus is assigned, the user apparatus assigning unit adds user apparatus ID information to the new piece of node information, and the device key generating unit adds a device key to the new piece of node information.

With the above-stated construction, the key management apparatus can deal with each piece of node information as a node in a tree structure since it stores the same number of pieces of node information as there are nodes in the tree structure and the pieces of node information are linked to each other in the same manner as the nodes in the tree structure.

In the above key management apparatus, the tree structure stored in the device key storage unit may be an n-ary tree structure, wherein n is an integer no smaller than 2, and the extending unit generates n new leaves extending from one leaf.

With the above-stated construction, the key management apparatus can extend the tree structure more easily since it uses an n-ary tree structure.

In the above key management apparatus, the tree structure stored in the device key storage unit may be an n-ary tree structure, wherein n is an integer no smaller than 2, and the extending unit generates m new leaves extending from one leaf, wherein m is an integer satisfying m>n.

With the above-stated construction, the key management apparatus can assign a great number of user apparatuses to device keys since the key management apparatus generates m (m>n) new leaves extending from one leaf in an n-ary tree structure.

In the above key management apparatus, the extending unit may generate m new leaves extending from one leaf, wherein m=n+1.

With the above-stated construction, the key management apparatus can assign a great number of user apparatuses to device keys and can extend the tree structure more easily since it generate n+1 new leaves extending from one leaf.

In the above key management apparatus, the extending unit may generate n further-new leaves extending from each of the n new leaves, resulting in generation of n² leaves.

With the above-stated construction, the key management apparatus can assign a great number of user apparatuses to device keys since the tree structure is extended by two layers per extension, and can extend the tree structure more easily since it does not change the n-ary tree structure in terms of the basic structure.

The above object can also be fulfilled by a user apparatus for either encrypting a content using one of a plurality of device keys assigned by a key management apparatus, which has one or more device keys for each node existing from each leaf to a root inclusive, and writing the encrypted content onto a recording medium or reading an encrypted content from the recording medium and decrypting the read content using one of the assigned device keys, wherein the key management apparatus (a) determines whether to add new leaves to the tree structure based on the number of leaves to which no user apparatus is assigned, (b) if it is determined to add, generates new leaves to extend from one of the leaves to which no user apparatus has been assigned, (c) assigns a user apparatus to one of the newly generated leaves, (d) generates and correlates new device keys with nodes with which no device key has been correlated, among all nodes existing from the one of the newly generated leaves to a root inclusive, and (e) assigns to the user apparatus all device keys corresponding to the nodes existing from the one of the newly generated leaves to the root inclusive, the user apparatus comprising: a media key identifying unit operable to identify an encrypted media key that was encrypted using one of the device keys assigned to the user apparatus, out of a plurality of encrypted media keys written on the recording medium; a media key decrypting unit operable to restore a media key by decrypting the identified encrypted media key using the device key that was used for encrypting the media key; and an encryption/decryption unit operable to either encrypt a content using the generated media key and write the encrypted content onto the recording medium or read an encrypted content from the recording medium and decrypt the read content using the generated media key.

With the above-stated construction, a user apparatus is correlated with a new leaf which is generated by the key management apparatus by extending a tree structure. Also, the set of device keys assigned to the user apparatus is unique to the user apparatus since the set of device keys consists of all device keys corresponding to the nodes existing from the newly generated leaf to the root inclusive. Accordingly, the user apparatus can be revoked.

The above object can also be fulfilled by a recording medium having recorded thereon: encrypted media keys that are generated by encrypting media keys using device keys as encryption keys, wherein the device keys are generated by a key management apparatus, and the key management apparatus (a) determines whether to add new leaves to the tree structure based on the number of leaves to which no user apparatus is assigned, (b) if it is determined to add, generates new leaves to extend from one of the leaves to which no user apparatus has been assigned, (c) assigns a user apparatus to one of the newly generated leaves, (d) generates and correlates new device keys with nodes with which no device key has been correlated, among all nodes existing from the one of the newly generated leaves to a root inclusive, and (e) assigns to the user apparatus all device keys corresponding to the nodes existing from the one of the newly generated leaves to the root inclusive.

With the above-stated construction, the user apparatus, to which device keys are assigned by the key management apparatus, can restore a media key by decrypting an encrypted media key recorded on the recording medium. The user apparatus obtains the media key using a device key, encrypts a content using the obtained media key, and records the encrypted content onto the recording medium. Alternatively, the user apparatus obtains the media key using a device key, and uses the obtained media key to decrypt an encrypted content recorded on the recording medium.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the construction of the digital work protection system 10;

FIG. 2 is a block diagram showing the construction of the key management apparatus 100;

FIG. 3 is a conceptual illustration of the tree structure T100;

FIG. 4 shows the data structure of the tree structure table D100;

FIG. 5 is a conceptual illustration of the tree structure T200;

FIG. 6 shows the data structure of the tree structure table D200;

FIG. 7 is a conceptual illustration of the tree structure T300;

FIG. 8 shows the data structure of the tree structure table D300;

FIG. 9 is a conceptual illustration of the tree structure T400;

FIG. 10 is a conceptual illustration of the tree structure T500;

FIG. 11 shows the data structure of the tree structure table D500;

FIG. 12 is a conceptual illustration of the tree structure T600;

FIG. 13 shows the data structure of the tree structure table D600;

FIG. 14 is a conceptual illustration of the tree structure T700;

FIG. 15 is a conceptual illustration of the tree structure T800;

FIG. 16 shows the data structure of the tree structure table D800;

FIG. 17 shows an example of the key information generated by the key management apparatus 100;

FIG. 18 is a flowchart showing an overall operation of the digital work protection system 10;

FIG. 19 is a flowchart showing the operation of the key management apparatus 100 in constructing and storing the first-generation tree structure;

FIG. 20 is a flowchart showing the operation of the key management apparatus 100 in a process for the n^{th}-generation tree structure;

FIG. 21 is a flowchart showing the operation of recording media and user apparatuses in a process for the n^{th}-generation tree structure;

FIG. 22 is a flowchart showing the operation of the key management apparatus 100 in outputting device keys and ID information to user apparatuses;

FIG. 23 shows a tree structure T900 in which the user apparatus 1 has been revoked;

FIG. 24A shows an encrypted media key stored in a recording medium 1100 before the user apparatus 1 is revoked in the tree structure T900; and

FIG. 24B shows encrypted media keys stored in a recording medium 1200 after the user apparatus 1 is revoked in the tree structure T900.

### DESCRIPTION OF THE PREFERRED EMBODIMENT

The following describes a digital work protection system 10 as an embodiment of the present invention, with reference to the attached drawings.

1. Structure of the Digital Work Protection System 10

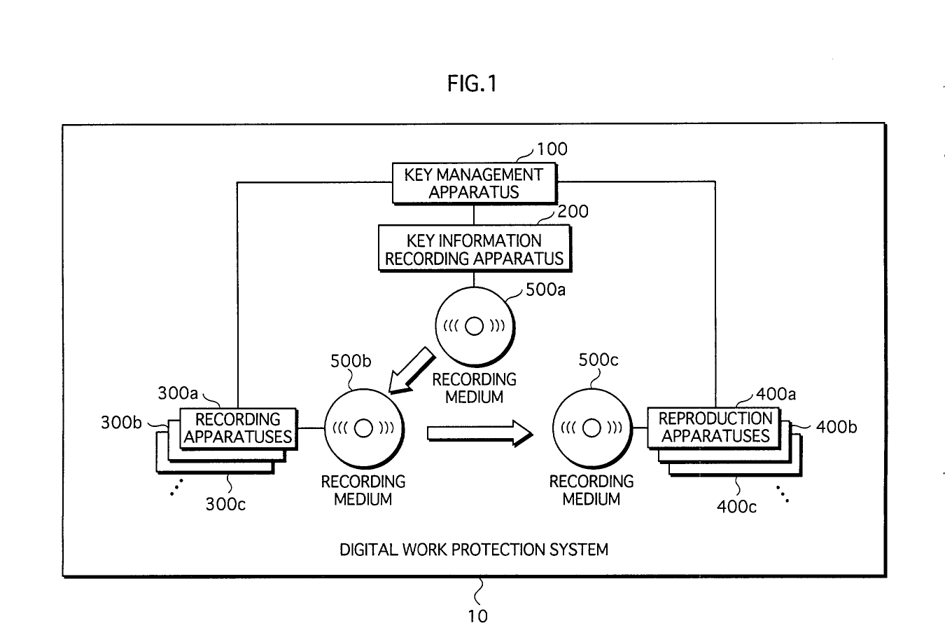

The digital work protection system 10, as shown in FIG. 1, is composed of a key management apparatus 100, a key information recording apparatus 200, recording apparatuses 300a, 300b, 300c, . . . (hereinafter referred to as “recording apparatuses 300a etc.”), and reproduction apparatuses 400a, 400b, 400c, . . . (hereinafter referred to as “reproduction apparatuses 400a etc.”).

The key management apparatus 100 has key information pre-recorded onto a recording medium 500a by the key information recording apparatus 200, resulting in a recording medium 500b on which the key information has been recorded being generated in advance. Note that the recording medium 500a is a recordable medium such as a DVD-RAM (Digital Versatile Disk Random Access Memory), onto which no information has been recorded. Furthermore, the key management apparatus 100 assigns device keys for decrypting key information respectively to each recording apparatus 300a etc. and each reproduction apparatus 400a etc., and distributes in advance the assigned device keys, device key identification information that identifies the device keys, and ID information that identifies the particular recording apparatus or reproduction apparatus, to each of the recording apparatuses 300a etc. and reproduction apparatuses 400a etc.

The recording apparatus 300a encrypts digitized content to generate encrypted content, and records the generated encrypted content on the recording medium 500b, resulting in a recording medium 500c being generated. The reproduction apparatus 400a reads the encrypted content from the recording medium 500c, and decrypts the read encrypted content to obtain the original content. The recording apparatuses 300b etc. operate in an identical manner to the recording apparatus 300a, and the reproduction apparatuses 400b etc. operate in an identical manner to the reproduction apparatus 400a.

Note that hereinafter “user apparatus” is used to refer to the recording apparatuses 300b etc. and the reproduction apparatuses 400b etc.

1.1 Key Management Apparatus 100

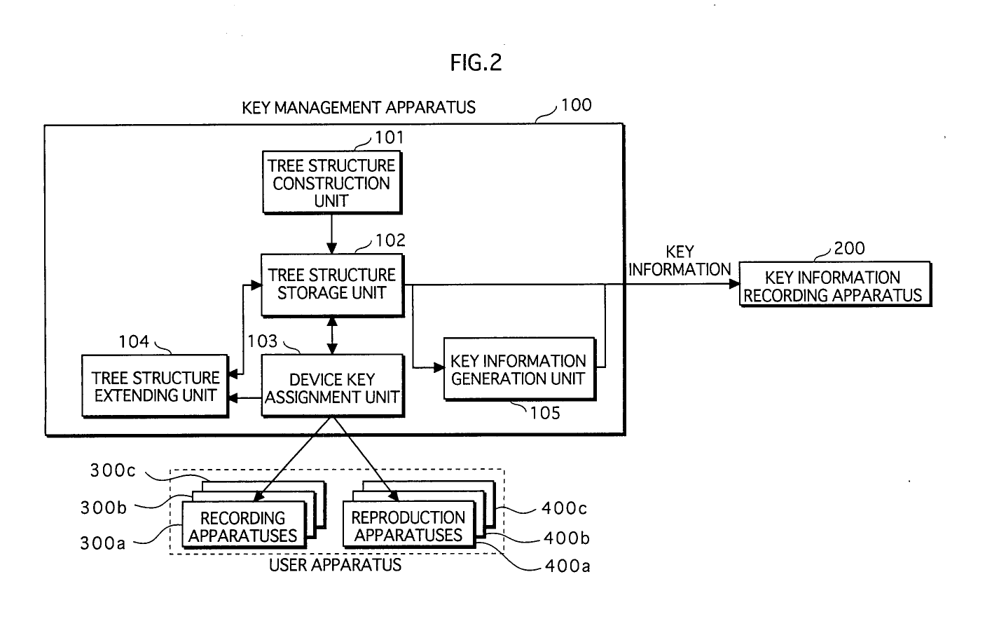

The key management apparatus 100, as shown in FIG. 2, is composed of a tree structure construction unit 101, a tree structure storage unit 102, a device key assignment unit 103, a tree structure extending unit 104, and a key information generation unit 105.

Specifically, the key management apparatus 100 is a computer system that includes a microprocessor, a ROM (Read Only Memory), a RAM (Random Access Memory), a hard disk unit, a display unit, a keyboard, and a mouse. Computer programs are stored in the RAM or the hard disk unit. The key management apparatus 100 achieves its functions by the microprocessor operating in accordance with the computer programs.

(1) Tree Structure Construction Unit 101

The tree structure construction unit 101 constructs a data structure corresponding to a binary tree that is used for managing device keys, and stores the constructed data structure in the tree structure storage unit 102. Here, the data structure constructed by the tree structure construction unit 101 is the initial tree structure prior to an extension in the digital work protection system 10. The system can extend the tree structure starting with the initial state. The initial tree structure is referred to as a first-generation tree structure.

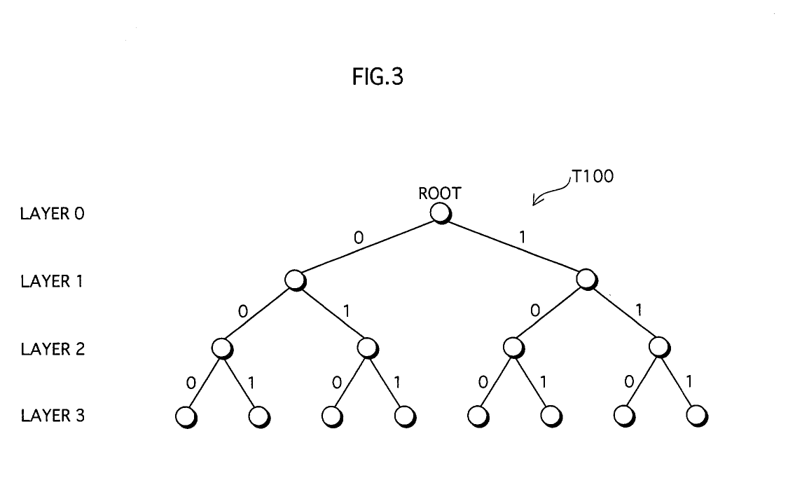

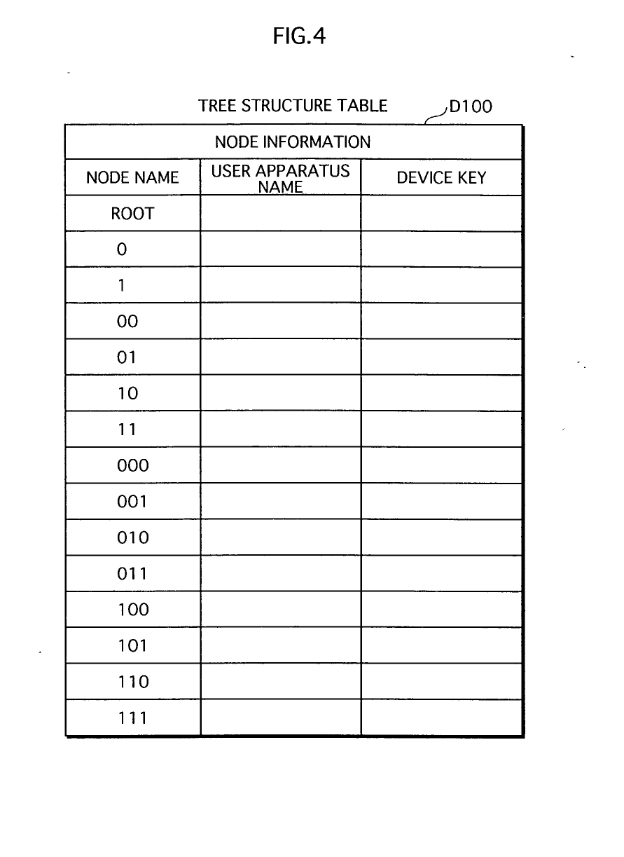

FIG. 4 specifically shows the data structure constructed by the tree structure construction unit 101. The tree structure table D100 shown in FIG. 4 corresponds to the tree structure T100 shown in FIG. 3.

Tree Structure T100

The tree structure T100 is, as shown in FIG. 3, a binary tree composed of four layers: layers 0-3. Each node in the tree structure T100 (excluding leaves) is connected to two lower nodes via two paths, respectively. The layer 0 has one node that is a root. The layer 1 has two nodes. The layer 2 has four nodes. The layer 3 has eight nodes that are referred to as leaves. It should be noted here that in the tree structure, a lower side is a leaf side and a higher side is a root side.

In the tree structure T100, a number “0” is assigned to a path on the left-hand side, and a number “1” to a path on the right-hand side, for each pair of paths connecting a node (excluding leaves) and two lower nodes. Hereinafter, in relation to the tree structure T100 shown in FIG. 3, the path on the left-hand side of a node is referred to as “a left path”, and the path on the right-hand side of a node is referred to as “a right path”.

Each node is assigned a node name. The node name of the root node is “root”. Each node belonging to the layers lower than the layer 0 is assigned a node name, the number of the characters constituting which is equivalent to the number contained in the layer name of the layer to which the node belongs. The node names are generated by arranging the numbers assigned to the paths connecting the target nodes and the root, in ascending order of the layer number. For example, the two nodes belonging to the layer 1 have node names “0” and “1”, respectively; the four nodes belonging to the layer 2 have node names “00”, “1”, “10”, and “11”, respectively; and the eight nodes belonging to the layer 3 have node names “000”, “001”, “010”, “011”, . . . “101”, “110”, and “111”, respectively.

Tree Structure Table D100

The tree structure construction unit 101 has in advance a tree structure table in which no data has been written. The tree structure construction unit 101 then writes data into the tree structure table to generate the tree structure table D100 shown in FIG. 4.

The tree structure table D100 contains the same number of pieces of node information as the number of nodes in the tree structure T100, and each piece of node information corresponds to a different node in the tree structure T100.

Each piece of node information includes a node name, a user apparatus name, and a device key. The node name identifies a node corresponding to the piece of node information. The user apparatus name identifies a user apparatus corresponding to the corresponding node. The device key is the one assigned to the corresponding node.

The tree structure construction unit 101 generates the tree structure table D100 by writing the node information into the previously held tree structure table, as follows.

The tree structure construction unit 101 writes the node information in correspondence with the nodes in the layers in the tree structure T100 in ascending order of the layer number. More specifically, the tree structure construction unit 101 first writes a piece of node information corresponding to the root belonging to the layer 0, then two pieces of node information corresponding to two nodes in the layer 1, then four pieces of node information corresponding to four nodes in the layer 2, and then eight pieces of node information corresponding to eight nodes in the layer 3.

For each layer, pieces of node information are written in correspondence with the nodes belonging to the layer, in ascending order of the number contained in the node names. Specifically, the pieces of node information are stored in the following order in the tree structure table D100 shown in FIG. 4:

“root”, “0”, “1”, “00”, “01”, “10”, “11”, “000”, “001”, “010”, “011”, . . . , “101”, “110”, “111”.

Here, the order in which the pieces of node information are stored is shown by the node name included in each piece of node information.

The tree structure construction unit 101 first generates a piece of node information with “root” as the node name, and writes the generated piece of node information to the tree structure table.

Next, the tree structure construction unit 101 generates node names “0” and “1” that identify the two nodes in layer 1, generates two pieces of node information that respectively include the generated node names “0” and “1”, and writes the two generated pieces of node information in the stated order to the tree structure table.

Next, the tree structure construction unit 101 generates four node names “00”, “01”, “10” and “11” that identify the four nodes in layer 2, generates four pieces of node information that respectively include “00”, “01”, “10” and “11”, and adds the four generated pieces of node information to the tree structure table in the stated order.

After this, the tree structure construction unit 101 generates eight pieces of node information for the layer 3 in the stated order, and writes the generated node information to the tree structure table, in the same manner as described above.

It should be noted here that of the node names, user apparatus names, and device keys contained in the node information, the data generated by the tree structure construction unit 101 is only the node names. The user apparatus names and device keys are generated and written into the tree structure table D100 by the device key assignment unit 103 and the tree structure extending unit 104 (which will be described in detail later), respectively,

(2) Tree Structure Storage Unit 102

The tree structure storage unit 102 is achieved by a certain area in a hard disk unit in which one tree structure table can be stored.

The tree structure storage unit 102 stores the tree structure table D100 output from the tree structure construction unit 101, or the tree structure table output from the device key assignment unit 103 or the tree structure extending unit 104.

(3) Device Key Assignment Unit 103

The device key assignment unit 103 has a threshold value in advance.

The device key assignment unit 103 reads the tree structure table from the tree structure storage unit 102, compares the threshold value with the number of leaves contained in the read tree structure table for which corresponding user apparatus names are not indicated to judge whether such number of leaves is greater than the threshold value, and if it is judged positively, selects a leaf from the leaves, and brings a user apparatus into correspondence with the selected leaf. The device key assignment unit 103 then generates device keys and assigns the generated device keys to certain nodes that are selected in relation to the selected leaf, and transmits the assigned device keys to the user apparatus that is in correspondence with the selected leaf. If the number of leaves contained in the read tree structure table for which corresponding user apparatus names are not indicated is not greater than the threshold value, the device key assignment unit 103 outputs the read tree structure table to the tree structure extending unit 104.

Now a detailed description will be provided presuming that the threshold value held by the device key assignment unit 103 is “4”.

First-Generation Tree Structure

In this section, how the device key assignment unit 103 processes the first-generation tree structure will be described.

The device key assignment unit 103 reads the tree structure table D100 from the tree structure storage unit 102, and extracts the eight pieces of node information from it. The device key assignment unit 103 counts the number of leaves for which corresponding user apparatus names are not indicated. The result is found to be “8”. The device key assignment unit 103 then compares the number with the threshold value “4”, and recognizes that it is greater than the threshold value.

The device key assignment unit 103 selects a leaf from the eight leaves. It is supposed that a leaf corresponding to a node name “000” is selected here. The device key assignment unit 103 then writes “1” as the user apparatus name into the piece of node information having the node name “000”. The device key assignment unit 103 then generates a plurality of device keys using random numbers. The device key assignment unit 103 assigns the generated device keys to all the nodes that exist from the leaf “000” to the root inclusive, and to all the roots of subtrees that are generated when these nodes are deleted. The device key assignment unit 103 writes the device keys in pieces of node information in the tree structure table that correspond to the assigned nodes and subtree roots.

The device key assignment unit 103 stores the updated tree structure table into the tree structure storage unit 102 in place of the previously stored tree structure table.

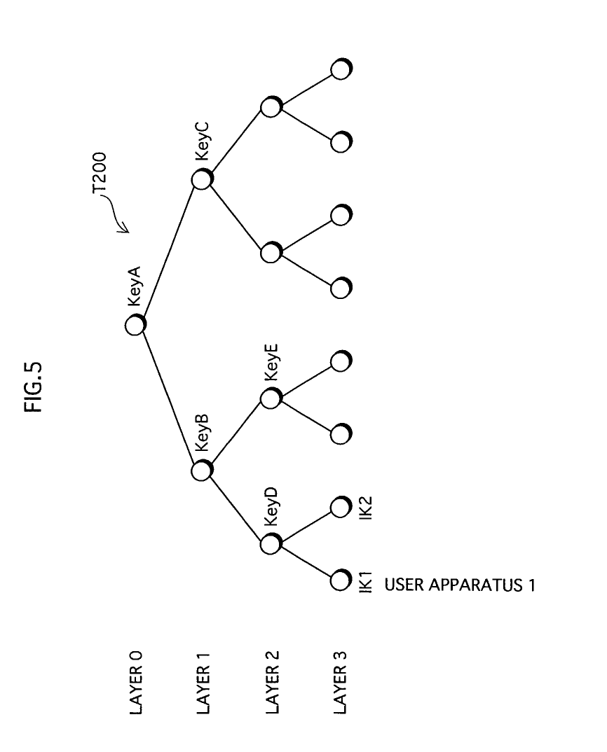

FIG. 5 shows a tree structure T200 that is generated as a result of the above-described operation.

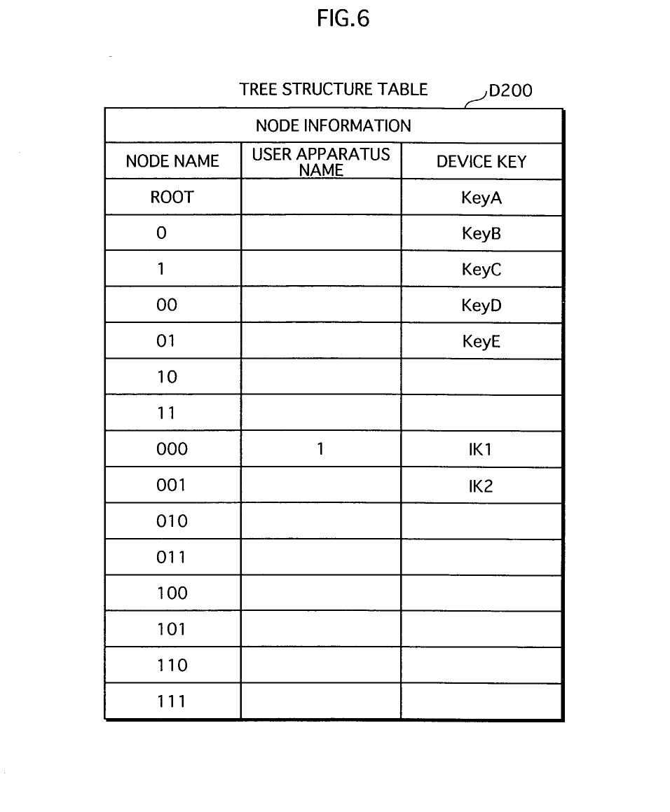

As shown in FIG. 5, the left-most leaf in the tree structure T200 corresponds to the user apparatus 1. FIG. 6 shows a tree structure table D200 that corresponds to the tree structure T200 and is currently stored in the tree structure storage unit 102. As shown in FIGS. 5 and 6, in the generated tree structure, the root corresponds to a device key “KeyA”, node “0” to “KeyB”, node “1” to “KeyC”, node “00” to “KeyD”, node “01” to “KeyE”, node “0” to “KeyB”, leaf “000” to “IK1”, and leaf “001” to “IK2”.

The device key assignment unit 103 reads the tree structure table D200 from the tree structure storage unit 102, and transmits the ID information, device keys, and the corresponding device key ID information to the user apparatus 1, as follows.

The device key assignment unit 103 obtains from the read tree structure table D200 a piece of node information that contains the user apparatus “1”, and extracts the node name and the device key from the detected piece of node information. In this example, the extracted node name and device key are “000” and “IK1”, respectively.

The device key assignment unit 103 then obtains from the tree structure table D200 a piece of node information that contains a node name “root”, and extracts the device key from the detected piece of node information. In this example, the extracted device key is “KeyA”.

The device key assignment unit 103 then obtains from the tree structure table D200 a piece of node information that contains a node name “0”, which is identical to the first bit of the above-detected node name “000”, and extracts the device key from the detected piece of node information. In this example, the extracted device key is “KeyB”.

The device key assignment unit 103 then obtains from the tree structure table D200 a piece of node information that contains a node name “00”, which is identical to the first two bits of the above-detected node name “000”, and extracts the device key from the detected piece of node information. In this example, the extracted device key is “KeyD”.

The device key assignment unit 103 then transmits the detected node name “000” to the user apparatus 1 as ID information, and assigns numerals “1”, “2”, “3”, and “4” respectively to the extracted four device keys “KeyA”, “KeyB”, “KeyD”, and “IK1” as device key ID information, and transmits the four device keys and the four pieces of device key ID information to the user apparatus 1 in the stated order.

The device key assignment unit 103 then generates another tree structure table by updating the tree structure table D200 stored in the tree structure storage unit 102, and stores the newly generated tree structure table into the tree structure storage unit 102.

The device key assignment unit 103 then, based on the newly stored tree structure table, transmits the ID information, four device keys and four pieces of device key ID information to the user apparatus 2.

Similarly, the device key assignment unit 103 transmits the ID information, four device keys and four pieces of device key ID information to the user apparatus 3. Further in a similar manner, the device key assignment unit 103 transmits the ID information, four device keys and four pieces of device key ID information to the user apparatus 4.

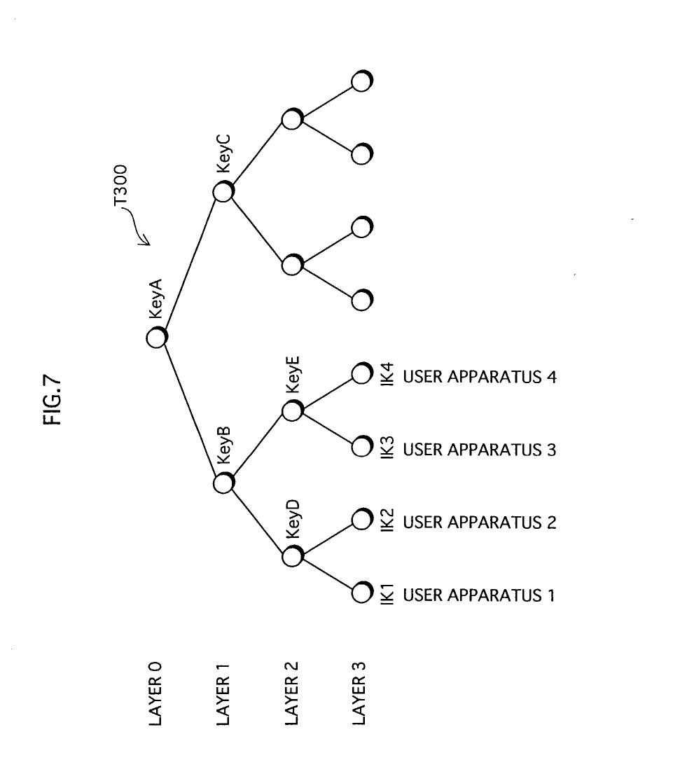

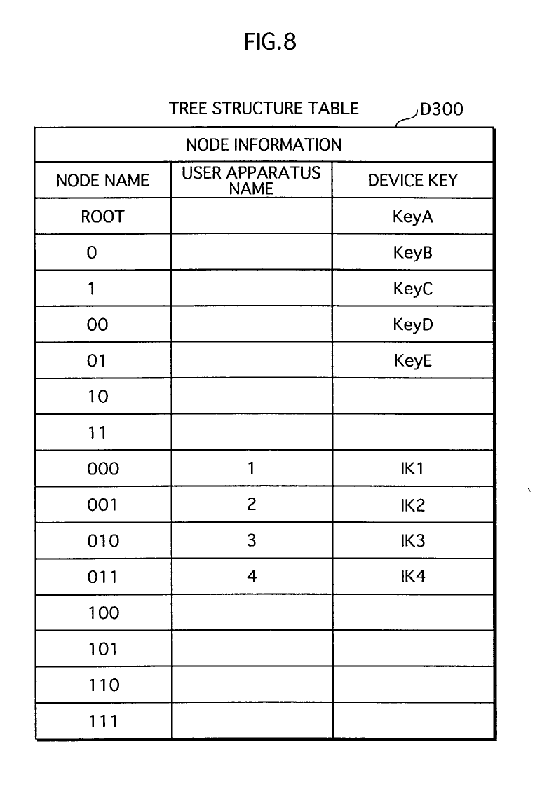

FIG. 7 shows a tree structure T300 generated as a result of the above stated processes. FIG. 8 specifically shows a tree structure table D300 that corresponds to the tree structure T300 and is stored in the tree structure storage unit 102. As shown in FIGS. 7 and 8, the device key assignment unit 103 has transmitted the ID information “001”, device keys “KeyA”, “KeyB”, “KeyD”, and “IK2”, and the corresponding device key ID information to the user apparatus 2, has transmitted the ID information “010”, device keys “KeyA”, “KeyB”, “KeyE”, and “IK3”, and the corresponding device key ID information to the user apparatus 3, and has transmitted the ID information “011”, device keys “KeyA”, “KeyB”, “KeyE”, and “IK4”, and the corresponding pieces of device key ID information to the user apparatus 4.

The device key assignment unit 103 then starts repeating the same procedure for the user apparatus 5. The device key assignment unit 103 reads the tree structure table D300 from the tree structure storage unit 102, and counts the number of leaves for which corresponding user apparatus names are not indicated. The result is found to be “4”. The value is not greater than the threshold value. When this happens, the device key assignment unit 103 restores the tree structure table D300 to the tree structure storage unit 102, and outputs to the tree structure extending unit 104 a signal containing an instruction to extend a tree structure corresponding to the tree structure table stored in the tree structure storage unit 102.

Second-Generation Tree Structure

In this section, how the device key assignment unit 103 processes the second-generation tree structure will be described. It should be noted here that the second-generation tree structure is generated by extending the first-generation tree structure so as to have five layers: layer 0 to layer 4.

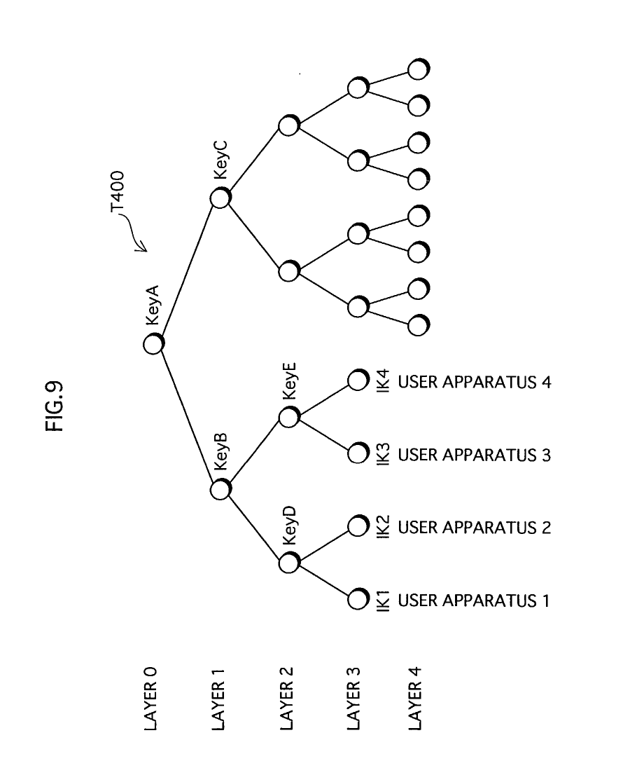

The device key assignment unit 103 reads the tree structure table D400 from the tree structure storage unit 102, where the tree structure table D400 is not illustrated, but represents the data structure corresponding to the tree structure T400 shown in FIG. 9. The device key assignment unit 103 then extracts from the table the eight pieces of node information for the eight leaves. The device key assignment unit 103 counts the number of leaves for which corresponding user apparatus names are not indicated. The result is found to be “8”. The device key assignment unit 103 then compares the number with the threshold value “4”, and recognizes that it is greater than the threshold value.

The device key assignment unit 103 selects a leaf from the eight leaves. It is supposed that a leaf corresponding to a node name “1000” is selected here. The device key assignment unit 103 then writes “5” as the user apparatus name into the piece of node information having the node name “1000”. The device key assignment unit 103 then generates a plurality of device keys using random numbers. The device key assignment unit 103 assigns the generated device keys to all the nodes that exist from the leaf “1000” to the root inclusive, and to all the roots of subtrees that are generated when these nodes are deleted. The device key assignment unit 103 writes the device keys in pieces of node information in the tree structure table that correspond to the assigned nodes and subtree roots.

The device key assignment unit 103 stores the updated tree structure table into the tree structure storage unit 102 in place of the previously stored tree structure table.

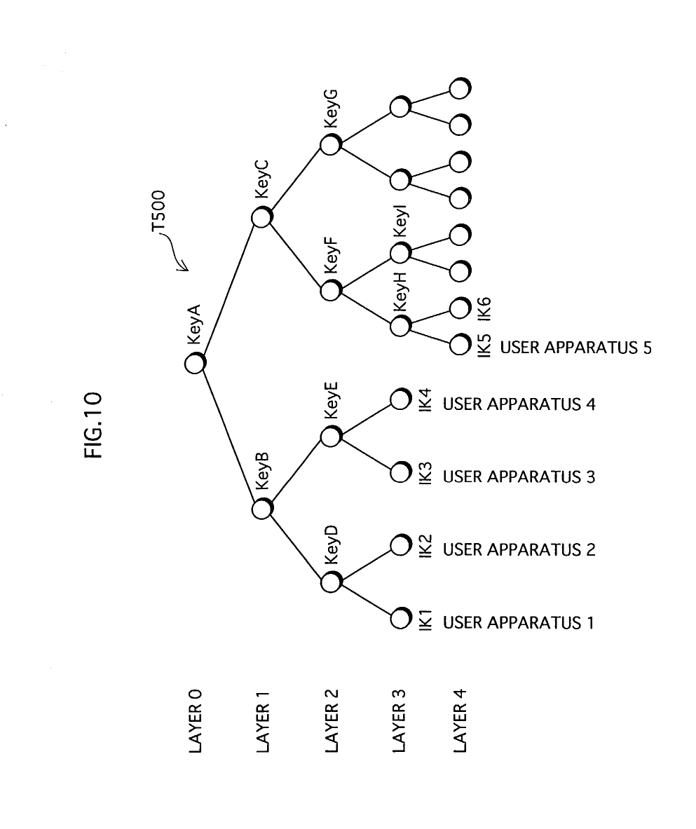

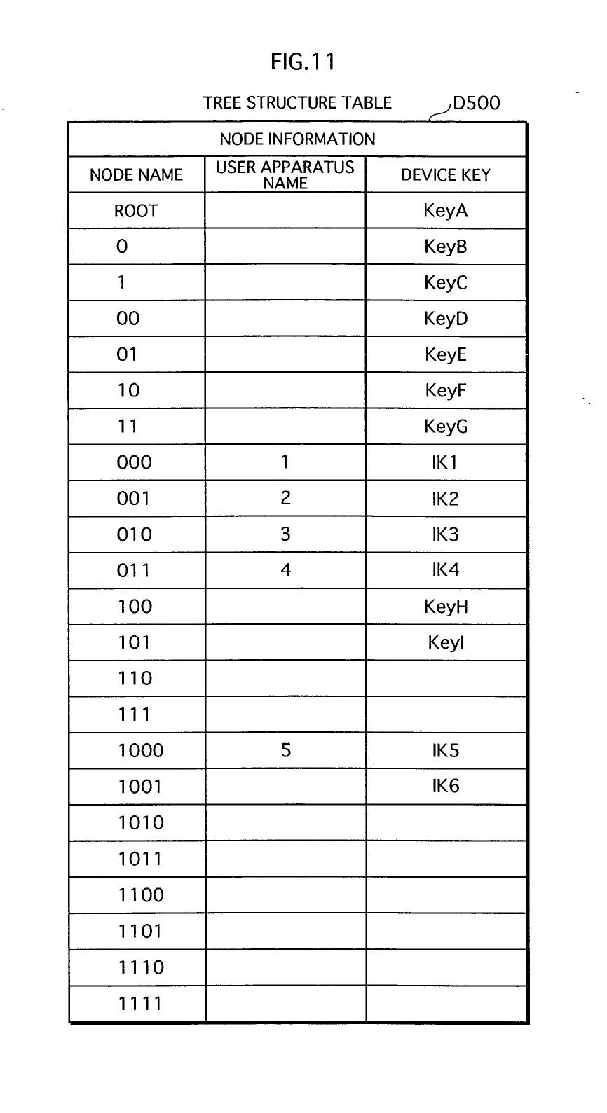

FIG. 10 shows a tree structure T500 that is generated as a result of the above-described operation. FIG. 11 shows a tree structure table D500 that corresponds to the tree structure T500 and is currently stored in the tree structure storage unit 102. As shown in FIGS. 10 and 11, the generated tree structure contains newly established correspondences: node “10” corresponds to a device key “KeyF”, node “11” to “KeyG”, node “100” to “KeyH”, node “101” to “KeyI”, leaf “1000” to “IK5”, and leaf “1001” to “IK6”.

The device key assignment unit 103 reads the tree structure table D500 from the tree structure storage unit 102, and transmits the ID information, device keys, and the corresponding device key ID information to the user apparatus 5, as follows.

The device key assignment unit 103 obtains from the read tree structure table D500 a piece of node information that contains the user apparatus “5”, and extracts the node name and the device key from the detected piece of node information. In this example, the extracted node name and device key are “1000” and “IK5”, respectively.

The device key assignment unit 103 then obtains from the tree structure table D500 a piece of node information that contains a node name “root”, and extracts the device key from the detected piece of node information. In this example, the extracted device key is “KeyA”.

The device key assignment unit 103 then obtains from the tree structure table D500 a piece of node information that contains a node name “1”, which is identical to the first bit of the above-detected node name “1000”, and extracts the device key from the detected piece of node information. In this example, the extracted device key is “KeyC”.

The device key assignment unit 103 then obtains from the tree structure table D500 a piece of node information that contains a node name “10”, which is identical to the first two bits of the above-detected node name “1000”, and extracts the device key from the detected piece of node information. In this example, the extracted device key is “KeyF”.

The device key assignment unit 103 then obtains from the tree structure table D500 a piece of node information that contains a node name “100”, which is identical to the first three bits of the above-detected node name “1000”, and extracts the device key from the detected piece of node information. In this example, the extracted device key is “KeyH”.

The device key assignment unit 103 then transmits the detected node name “1000” to the user apparatus 1 as ID information, and assigns numerals “1”, “2”, “3”, “4”, and “5” respectively to the extracted five device keys “KeyA”, “KeyC”, “KeyF”, “KeyH”, and “IK5” as device key ID information, and transmits the five device keys and the five pieces of device key ID information to the user apparatus 5 in the stated order.

The device key assignment unit 103 then generates another tree structure table by updating the tree structure table D500 stored in the tree structure storage unit 102, and stores the newly generated tree structure table into the tree structure storage unit 102.

The device key assignment unit 103 then, based on the newly stored tree structure table, transmits the ID information, five device keys and five pieces of device key ID information to the user apparatus 6.

Similarly, the device key assignment unit 103 transmits the ID information, five device keys and five pieces of device key ID information to the user apparatus 7. Further, in a similar manner, the device key assignment unit 103 transmits the ID information, five device keys and five pieces of device key ID information to the user apparatus 8.

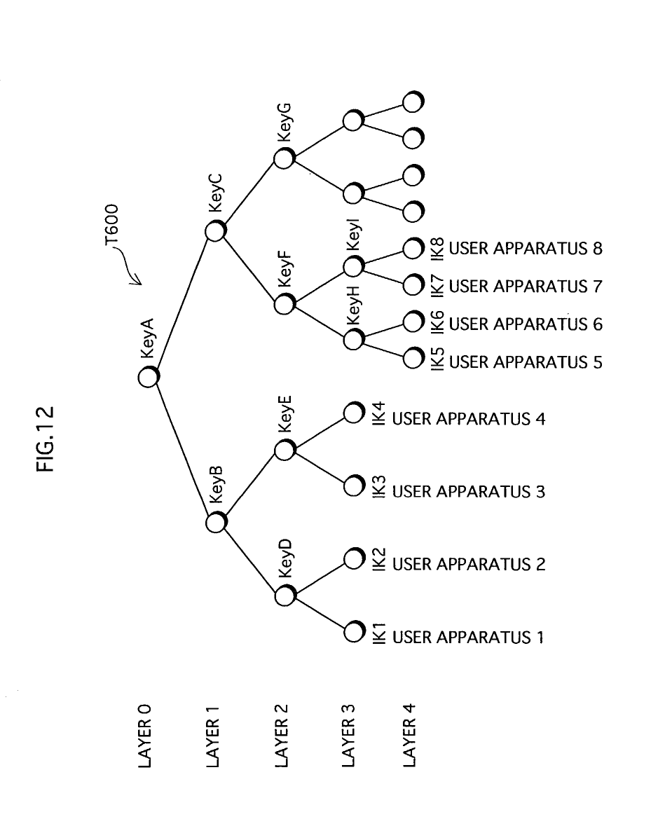

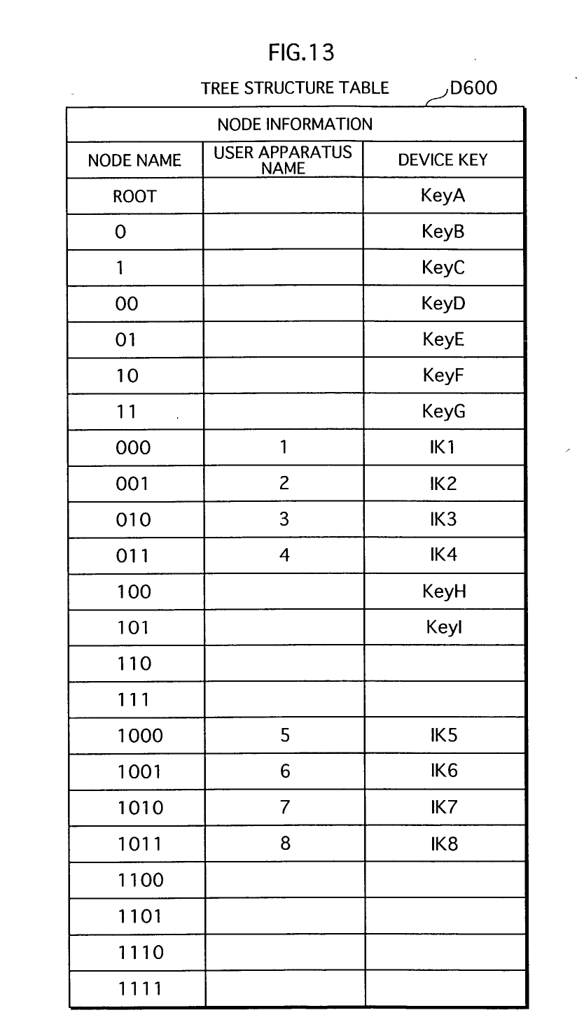

FIG. 12 shows a tree structure T600 generated as a result of the above stated processes. As shown in FIG. 12, all the four leaves belonging to the layer 3 are assigned to user apparatuses; and out of the eight leaves belonging to the layer 4, four leaves are assigned to user apparatuses, but the other four leaves are not assigned to user apparatuses. FIG. 13 shows a tree structure table D600 that corresponds to the tree structure T600 and is currently stored in the tree structure storage unit 102. As shown in FIGS. 12 and 13, the device key assignment unit 103 has transmitted the ID information “1001”, device keys “KeyA”, “KeyC”, “KeyF”, “KeyH”, and “IK6” to the user apparatus 6, has transmitted the ID information “1010”, device keys “KeyA”, “KeyC”, “KeyF”, “KeyI”, and “IK7” to the user apparatus 7, and has transmitted the ID information “1011”, device keys “KeyA”, “KeyC”, “KeyF”, “KeyI”, and “IK8” to the user apparatus 8.

The device key assignment unit 103 then starts repeating the same procedure for the user apparatus 9. The device key assignment unit 103 reads the tree structure table D600 from the tree structure storage unit 102, and counts the number of leaves for which corresponding user apparatus names are not indicated. The result is found to be “4”. The value is not greater than the threshold value. When this happens, the device key assignment unit 103 restores the tree structure table D600 to the tree structure storage unit 102, and outputs to the tree structure extending unit 104 a signal containing an instruction to extend a tree structure corresponding to the tree structure table stored in the tree structure storage unit 102.

Third-Generation Tree Structure

In this section, how the device key assignment unit 103 processes the third-generation tree structure will be described. It should be noted here that the third-generation tree structure is generated by extending the second-generation tree structure so as to have six layers: layer 0 to layer 5.

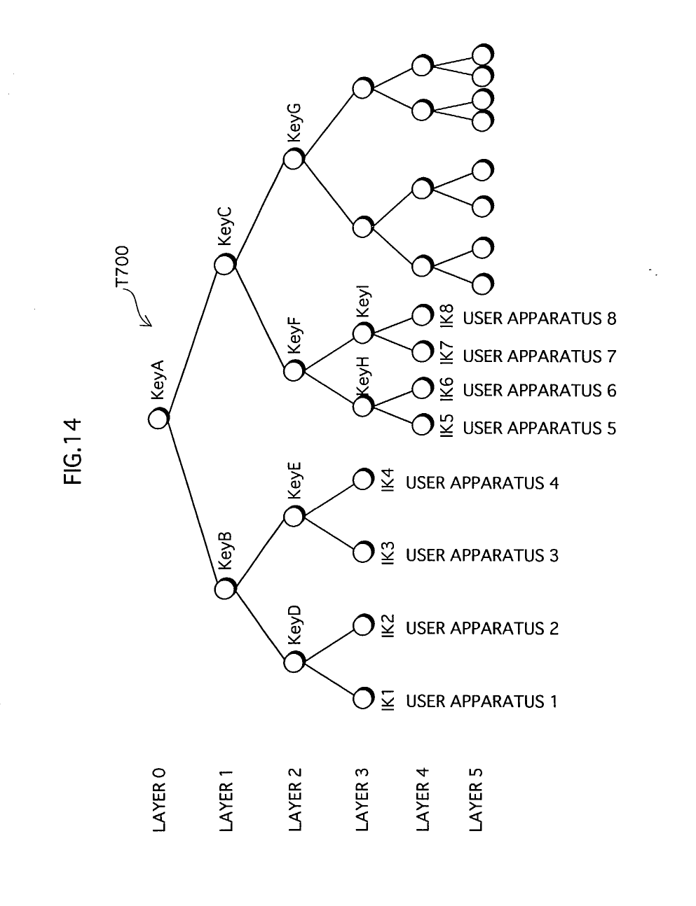

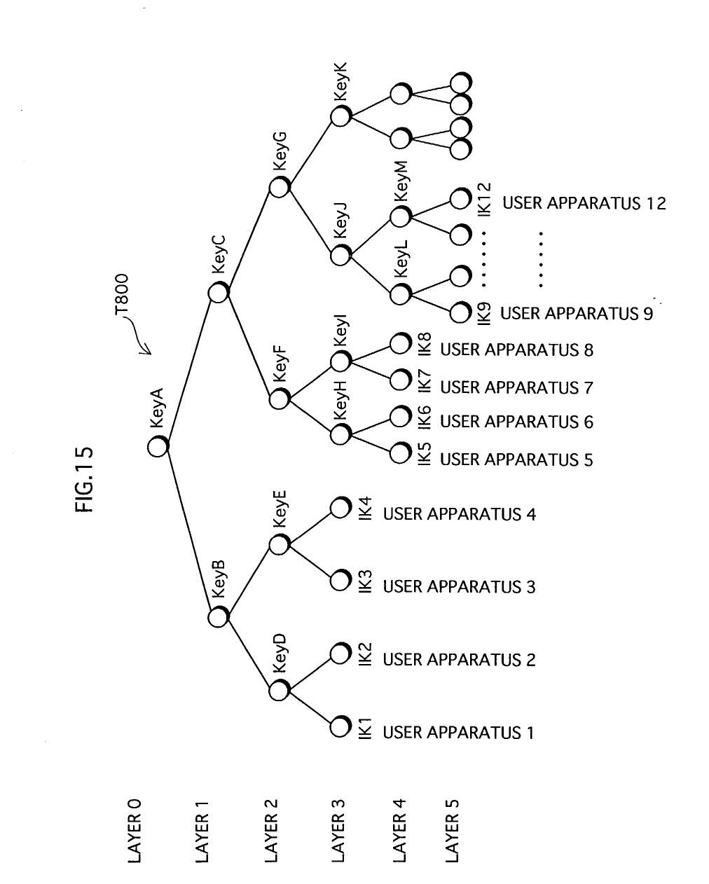

The device key assignment unit 103 assigns a user apparatus 9 to a leaf belonging to the layer 5 in a tree structure T700 shown in FIG. 14. The device key assignment unit 103 further correlates certain nodes with device keys. Then, after a similar process to that for the second-generation tree structure, a tree structure T800 shown in FIG. 15 is generated.

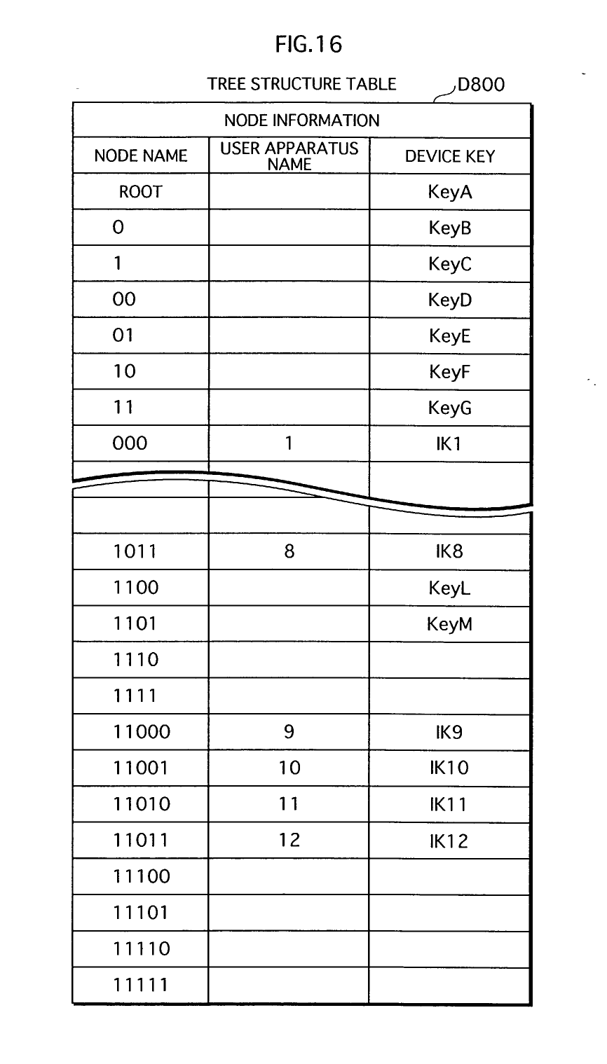

In the tree structure T800, as shown in FIG. 15, all the four leaves belonging to the layer 3 and all the four leaves belonging to the layer 4 are assigned to user apparatuses; and out of the eight leaves belonging to the layer 5, four leaves are assigned to user apparatuses, but the other four leaves are not assigned to user apparatuses. FIG. 16 shows a tree structure table D800 that corresponds to the tree structure T800 and is currently stored in the tree structure storage unit 102. As shown in FIGS. 15 and 16, the device key assignment unit 103 has transmitted the ID information “11000”, device keys “KeyA”, “KeyC”, “KeyG”, “KeyJ”, “KeyL”, and “IK9” and the corresponding device key ID information to the user apparatus 9, has transmitted the ID information “11001”, device keys “KeyA”, “KeyC”, “KeyG”, “KeyJ”, “KeyL”, and “IK10” and the corresponding device key ID information to the user apparatus 10, has transmitted the ID information “11010”, device keys “KeyA”, “KeyC”, “KeyG”, “KeyJ”, “KeyM”, and “IK11” and the corresponding device key ID information to the user apparatus 11, and has transmitted the ID information “11011”, device keys “KeyA”, “KeyC”, “KeyG”, “KeyJ”, “KeyM”, and “IK12” and the corresponding device key ID information to the user apparatus 12.

The device key assignment unit 103 then starts repeating the same procedure for the user apparatus 13. The device key assignment unit 103 reads the tree structure table D800 from the tree structure storage unit 102, and counts the number of leaves for which corresponding user apparatus names are not indicated. The result is found to be “4”. The value is not greater than the threshold value. When this happens, the device key assignment unit 103 restores the tree structure table D800 to the tree structure storage unit 102, and outputs to the tree structure extending unit 104 a signal containing an instruction to extend a tree structure corresponding to the tree structure table stored in the tree structure storage unit 102.

(4) Tree Structure Extending Unit 104

The tree structure extending unit 104, upon receipt of a signal containing an instruction to extend a tree structure from the device key assignment unit 103, reads a tree structure table from the tree structure storage unit 102, extend the tree structure corresponding to the read tree structure table by one generation by updating the tree structure table, and stores the updated tree structure table into the tree structure storage unit 102. The following is a detailed description of this process.

The tree structure tables D300, D600, and D800 respectively shown in FIGS. 8, 13, and 16 are read by the tree structure extending unit 104 from the tree structure storage unit 102, for example. The tables correspond to the tree structures T300, T600, and T800 shown in FIGS. 7, 12, and 15, respectively. As the corresponding tree structure indicates, each of the tree structure tables D300, D600, and D800 has four leaves to which no user apparatus has been assigned.

When it reads the tree structure table D300 from the tree structure storage unit 102, the tree structure extending unit 104 generates eight leaves belonging to the layer 4 by generating two nodes extending from each leaf that belongs to the layer 3 and has no user apparatus assigned thereto. More specifically, the tree structure extending unit 104 generates eight pieces of node information containing node names “1000”, “1001”, “1010”, “1011”, “1100”, “1101”, “1110”, and “1111”, respectively, adds the generated eight pieces of node information to the tree structure table D300, and stores the new tree structure table into the tree structure storage unit 102. The new tree structure table is the tree structure table D400 shown in FIG. 9.

When it reads the tree structure table D600 from the tree structure storage unit 102, the tree structure extending unit 104 generates eight leaves belonging to the layer 5 by generating two nodes extending from each leaf that belongs to the layer 4 and has no user apparatus assigned thereto. More specifically, the tree structure extending unit 104 generates eight pieces of node information containing node names “11000”, “11001”, “11010”, “11011”, “11100”, “11101”, “11110”, and “11111”, respectively, adds the generated eight pieces of node information to the tree structure table D600, and stores the new tree structure table into the tree structure storage unit 102. The new tree structure corresponding to the new tree structure table is the tree structure T700 shown in FIG. 14.

Similarly, when it reads the tree structure table D800 from the tree structure storage unit 102, the tree structure extending unit 104 generates eight leaves belonging to the layer 6 by generating two nodes extending from each leaf that belongs to the layer 5 and has no user apparatus assigned thereto. More specifically, the tree structure extending unit 104 generates eight pieces of node information, and adds the generated node information to the tree structure table D800, and stores the new tree structure table into the tree structure storage unit 102.

It should be noted here that a fourth-generation tree structure and the corresponding tree structure table are not illustrated.

(5) Key Information Generation Unit 105

The key information generates key information and writes the generated information onto a recording medium 500a. Each piece of key information includes one or more pairs of ID information and an encrypted media key.

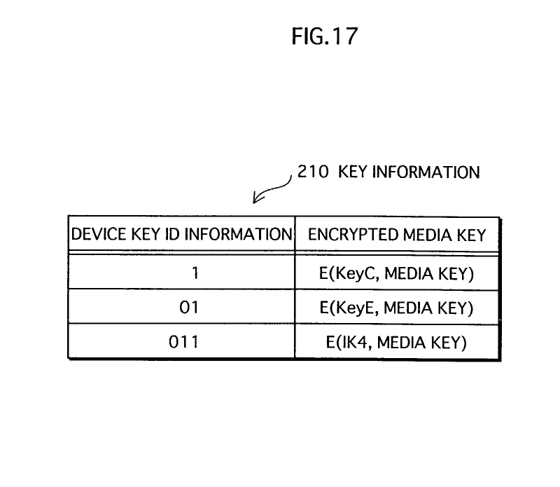

FIG. 17 shows an example of the key information generated by the key information generation unit 105. In this example, the key information 210 includes three pairs of (a) device key ID information and (b) an encrypted media key.

In this example, each encrypted media key is represented in the form of E (“device key”, “media key”). Here, “E(A, B)” indicates that data B is encrypted by an encryption algorithm E with use of a key A. The encryption algorithm E is DES (Data Encryption Standard), for example.

The device key ID information is used to identify a device key that is used to generate a corresponding encrypted media key. A node name of a node to which the target device key is assigned in the tree structure is written in the device key ID information.

1.2 Key Information Recording Apparatus 200

The key information recording apparatus 200 receives the key information from the key information generation unit 105, and writes the received the key information onto the recording medium 500a.

1.3 Recording Media 500a, b, c

The recording medium 500a is a recordable medium such as DVD-RAM, and has no data recorded thereon.

The recording medium 500b is generated when the key management apparatus 100 and the key information recording apparatus 200 write the key information on to the recording medium 500a.

The recording medium 500c is generated when any of the recording apparatuses 300a etc. writes an encrypted content.

1.4 Recording Apparatuses 300a etc.

The recording apparatus 300a includes a microprocessor, a ROM, and a RAM. The RAM stores a computer program. The functions of the recording apparatus 300a are achieved when the microprocessor operates in accordance with the computer program. The construction of the recording apparatus 300a is not illustrated.

The recording medium 500b is inserted into the recording apparatus 300a. The recording apparatus 300a identifies an encrypted media key to be decrypted and a device key to be used, by analyzing the device key ID information written in the key information recorded on the recording medium 500b, based on the ID information stored in the recording apparatus 300a itself. The recording apparatus 300a then obtains a media key by decrypting the identified encrypted media key using the identified device key, encrypts a digital content using the obtained media key, and records the encrypted content onto the recording medium 500b.

1.5 Reproduction Apparatuses 400a etc.

The reproduction apparatus 400a includes a microprocessor, a ROM, and a RAM. The RAM stores a computer program. The functions of the reproduction apparatus 400a are achieved when the microprocessor operates in accordance with the computer program. The construction of the reproduction apparatus 400a is not illustrated.

The recording medium 500c is inserted into the reproduction apparatus 400a. The reproduction apparatus 400a identifies an encrypted media key to be decrypted and a device key to be used, by analyzing the device key ID information written in the key information recorded on the recording medium 500c, based on the ID information stored in the reproduction apparatus 400a itself. The reproduction apparatus 400a then obtains a media key by decrypting the identified encrypted media key using the identified device key. The reproduction apparatus 400a then decrypts an encrypted digital content recorded on the recording medium 500c using the obtained media key to reproduce the content.

2. Operation of the Digital Work Protection System 10

In this section, the operation of the digital work protection system 10 will be explained.

2.1 Overall Operation

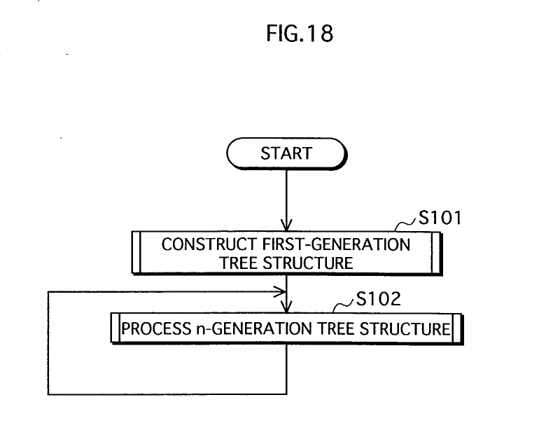

An overall operation of the digital work protection system 10 will be explained with reference to a flowchart shown in FIG. 18.

First, the digital work protection system 10 constructs a first-generation tree structure and stores the generated tree structure (step S101). The digital work protection system 10 then performs a process for an n^{th}-generation tree structure (step S102), where N is an integer no smaller than “2”. The step S102 is repeated as necessary.

2.2 Construction and Storing of the First-Generation Tree Structure

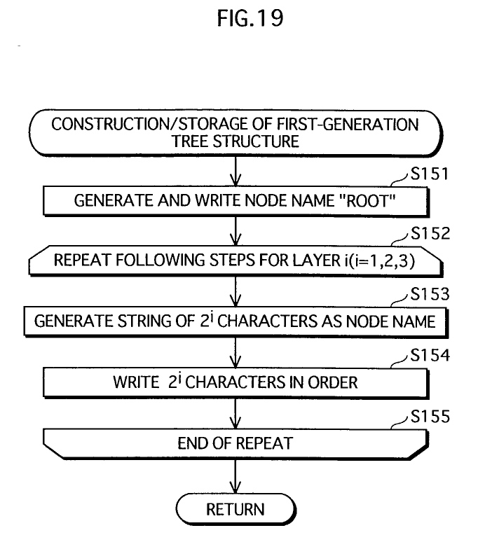

The operation of the key management apparatus 100 in constructing the first-generation tree structure will be explained with reference to a flowchart shown in FIG. 19. Note that the operation explained here is detail of step S101 shown in FIG. 18.

The tree structure construction unit 101 generates node information that includes “root” as the node name, and writes the generated node information to the tree structure table held by the tree structure construction unit 101 (step S151).

Next, the tree structure construction unit 101 repeats the following steps S152 to S155 for layer i (i=1,2,3).

The tree structure construction unit 101 generates a string of 2ⁱ characters as the node name (step S153), and writes node information that includes the string of 2ⁱ characters as the node name in order to the tree structure table (step S154).

2.3 Processing n^{th}-Generation Tree Structure

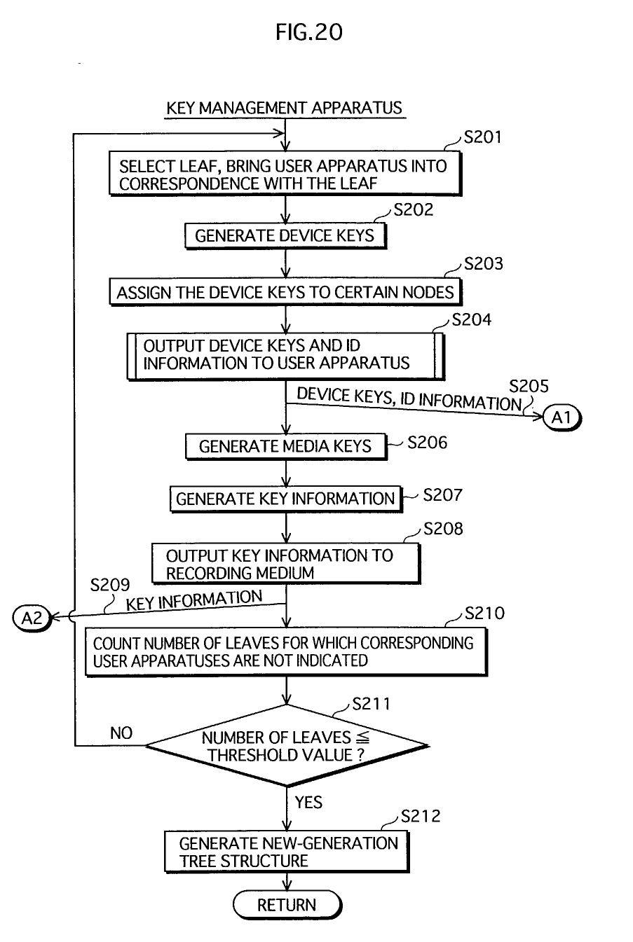

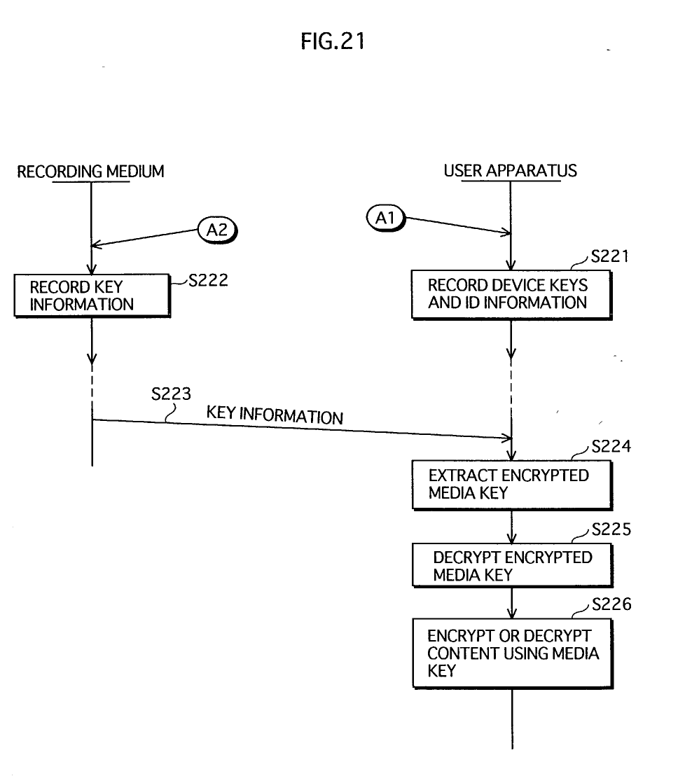

The operation of the present system in constructing the n^{th}-generation tree structure will be explained with reference to flowcharts shown in FIGS. 20 and 21. Note that the operation explained here is detail of step S102 shown in FIG. 18.

The device key assignment unit 103 of the key management apparatus 100 selects a leaf and brings a user apparatus into correspondence with the selected leaf (step S201). The device key assignment unit 103 then generates device keys (step S202) and assigns the generated device keys to certain nodes that are related to the selected leaf (step S203), and transmits the assigned device keys and the ID information to the user apparatus that is in correspondence with the selected leaf (step S204). The user apparatus receives the device keys and the ID information (step S205). The key information generation unit 105 generates media keys (step S206), and generates key information (step S207) The key information generation unit 105 outputs the generated key information to a recording medium via the key information recording apparatus 200 (step S208). The recording medium receives the key information (step S209). The device key assignment unit 103 counts the number of leaves for which corresponding user apparatus names are not indicated (step S210). The device key assignment unit 103 then judges whether the number of leaves is equal to or smaller than the threshold value (step S211). If it is judged positively, the tree structure extending unit 104 generates a new-generation tree structure (step S212). If it is judged negatively in step S211, the control returns to step S201.

After receiving the device keys and the ID information in step 205, the user apparatus stores in itself the received device keys and ID information (step S221).

After receiving the key information in step 209, the recording medium stores in itself the received key information (step S222).

While the recording medium is inserted in the user apparatus, the recording medium outputs the key information to the user apparatus, and the user apparatus receives the same (step S223). The user apparatus extracts the encrypted media key by referring to the key information (step S224). The user apparatus decrypts the extracted encrypted media key, with use of a device key (step S225), and encrypts or decrypts a content using the obtained media key (step S226).

2.4 Outputting Device Keys and ID Information

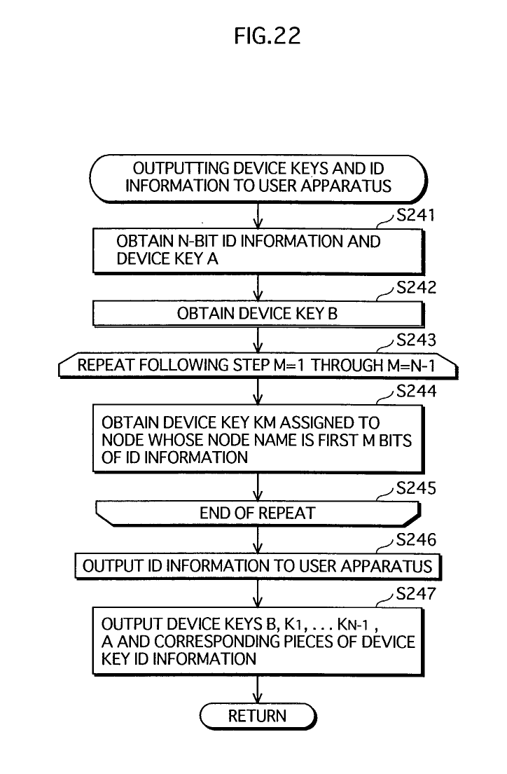

The operation of the key management apparatus 100 in outputting the device keys and ID information to the user apparatus will be explained with reference to the flow chart shown in FIG. 22. Note that the operation explained here is detail of step S204 shown in FIG. 20.

The device key assignment unit 103 obtains N-bit ID information and a device key “A” assigned to the selected leaf (step S241). The device key assignment unit 103 then obtains a device key “B” assigned to the root (step S242). The device key assignment unit 103 repeats step S244 for M=1 through M=N−1 (steps S243 to S245). The device key assignment unit 103 obtains a device key “K_{M}” assigned to a node whose node name is the first M bits of the ID information (step S244). The device key assignment unit 103 outputs the ID information to the user apparatus (step S246), then brings the obtained device keys into correspondence with pieces of device key ID information, and outputs the device keys and pieces of device key ID information to the user apparatus in the order of “B, K₁, . . . K_{N-1}, A” (step S247).

3. Revoking Device Keys

In this section, how device keys are revoked in the digital work protection system 10 by using a conventional device key revoke method. In relation to this, the compatibility between the user apparatuses will also be discussed.

The first-generation tree structure T300 shown in FIG. 7 is extended and the second-generation tree structure T600 shown in FIG. 12 is generated. In this extension, the number of layer is increased by one and four user apparatuses are added to the system. In this case, five device keys (KeyA, KeyC, KeyF, KeyI, and IK8) are assigned to the user apparatus 8, for example. The set of five device keys is unique to the user apparatus 8, different from any set of device keys assigned to other user apparatuses. As a result, it is possible to revoke the user apparatus 8 individually, as is known in the technical field.

Similarly, the second-generation tree structure T600 is extended and the third-generation tree structure T800 shown in FIG. 15 is generated. In this extension, the number of layer is increased by one and four user apparatuses are further added to the system. In this case, six device keys (KeyA, KeyC, KeyG, KeyJ, KeyM, and IK12) are assigned to the user apparatus 12, for example. The set of six device keys is unique to the user apparatus 12, different from any set of device keys assigned to other user apparatuses. As a result, it is possible to revoke the user apparatus 12 individually, as is known in the technical field.

Now, compatibility between (i) a user apparatus that is correlated with a tree structure when the third-generation tree structure is generated (hereinafter the user apparatus is referred to as a third-generation user apparatus. This is also applied to other generations) and (ii) a user apparatus that is correlated with the tree structure when another-generation tree structure is generated will be discussed.

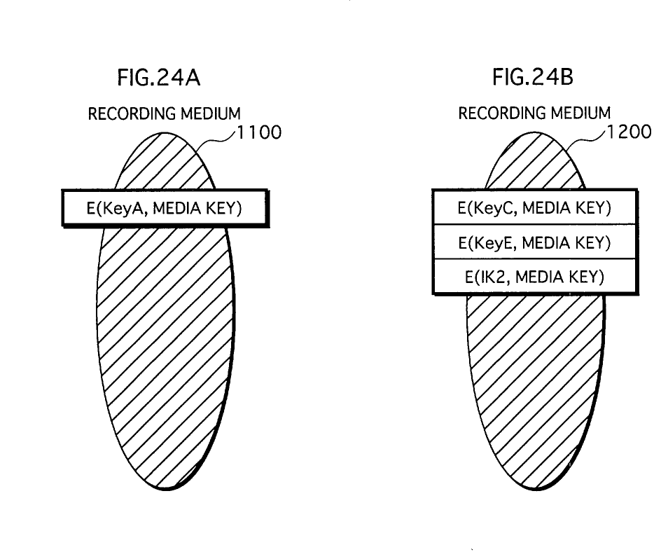

The tree structure T800 shown in FIG. 15 is in a state where no apparatus has been revoked. In this state, an encrypted media key, which is generated by encrypting a media key using the device key “KeyA”, is recorded in a recording medium 1100, as shown in FIG. 24A. When the user apparatus 12 is a recording apparatus, the user apparatus 12 obtains a media key by decrypting the encrypted media key using the device key “KeyA”, encrypts a digital content using the obtained media key, and records the encrypted content onto the recording medium 1100. When the first-generation user apparatus 1 is a reproduction apparatus, the user apparatus 1 obtains a media key by decrypting the encrypted media key using the device key “KeyA”, decrypts an encrypted digital content recorded on the recording medium 1100 using the obtained media key to reproduce the content.

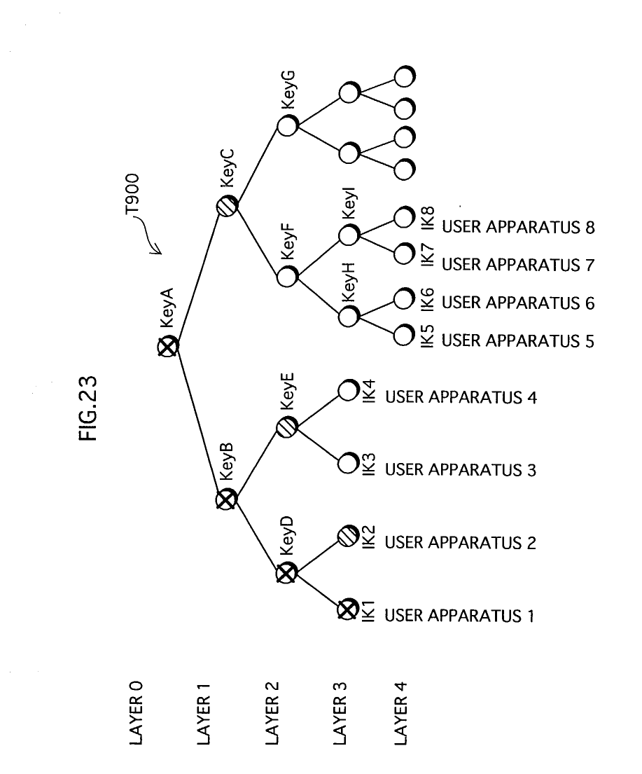

Next, a case where the first-generation user apparatus 1 has been revoked before the user apparatus 12 is added to the system will be discussed. FIG. 23 shows a tree structure T900 in which the user apparatus 1 has been revoked. At this point of time, the system includes two kinds of recording media: the recording medium 1100 that is shown in FIG. 24A and contains data before the user apparatus 1 is revoked; and the recording medium 1200 that is shown in FIG. 24B and contains data after the user apparatus 1 is revoked. The recording medium 1200 stores encrypted media keys that are encrypted using device keys “KeyC”, “KeyE”, and “IK2” as the key information. If the user apparatus 12 is added to the system in this condition, the user apparatus 12 holds device keys “KeyA”, “KeyC”, “KeyG”, “KeyJ”, “KeyM”, and “IK12” as shown in FIG. 15. In this state, the user apparatus 12, when the recording medium 1100 is inserted therein, obtains a media key using KeyA, encrypts a content using the obtained media key, and records the encrypted content onto the recording medium 1100. When the recording medium 1100 storing an encrypted content is inserted therein, the user apparatus 12 obtains a media key using KeyA, and decrypts the encrypted content using the obtained media key. Also, the user apparatus 12, when the recording medium 1200 is inserted therein, obtains a media key using KeyC, encrypts a content using the obtained media key, and records the encrypted content onto the recording medium 1200. When the recording medium 1200 storing an encrypted content is inserted therein, the user apparatus 12 obtains a media key using KeyC, and decrypts the encrypted content using the obtained media key.

6. Other Modifications

Note that although the present invention has been described based on the above embodiment, the present invention is not limited thereto. Cases such as the following are also included in the present invention.

(1) In the above embodiment, the key management apparatus 100 constructs a binary tree. However, not limited to the binary trees, the key management apparatus 100 may construct n-ary trees, where n is an integer no smaller than 2.

(2) In the above embodiment, any method can be used to correlate device keys with nodes in a tree structure or to assign user apparatuses to the device keys.

(3) In the above embodiment, each node in a tree structure is correlated with one device key. However, each node may be correlated with a plurality of device keys. In this case, for each node existing from a leaf, to which a user apparatus is assigned, to a root (including the leaf and the root), the key management apparatus assigns one or more device keys among the plurality of device keys correlated with the node, to the user apparatus. For example, the present invention includes the case in which each node of a ternary tree is correlated with six or seven device keys, and of these, three or four device keys are assigned to a user apparatus.

(4) In the above embodiment, the key management apparatus 100 has a threshold value in advance. However, the key management apparatus may not have a threshold value in advance, but receive a threshold value at the start of constructing a tree structure so as to set it therein. Furthermore, the key management apparatus may receive a threshold value to replace an old threshold value in the middle of a tree structure construction.

(5) In the above embodiment, the key management apparatus 100 first constructs a binary tree structure, then extends it by generating two leaves per one leaf. However, the key management apparatus may extends the tree structure by generating three leaves per one leaf. Furthermore, the key management apparatus may first construct an n-ary tree structure, then extends it by generating m leaves per one leaf, where n is an integer no smaller than 2, and m is an integer no smaller than n.

(6) In the above embodiment, the key management apparatus 100 extends the tree structure by one generation and assigns user apparatuses to the leaves. However, the key management apparatus 100 may extend the tree structure by two generations at once. For example, the key management apparatus may extend the tree structure T300 shown in FIG. 7 by two generations at once by generating 16 leaves belonging to the layer 5 from the four leaves that belong to the layer 3 and are not assigned to any user apparatuses. Furthermore, the key management apparatus 100 may extend the tree structure by k generations at once, where k is an integer no smaller than 2.

(7) In the above embodiment, the first-generation tree structure is constructed first, then the tree structure is extended up to the third-generation tree structure. However, not limited up to the third-generation tree structure, the tree structure maybe extended limitlessly, in principle. Also, the extension of the tree structure may be stopped when the number of layers in the tree structure reaches a predetermined number.

(8) The key management apparatus may select a tree structure extension method depending on the number of user apparatuses to be assigned to device keys. The tree structure extension method mentioned here includes a method of extending an n-ary tree by an n-ary tree, a method of extending an n-ary tree by an m-ary tree (n<m), a method of extending a tree by k generations at once (k is an integer no smaller than 2), and any combination of these methods.

(9) The present invention may be methods shown by the above. Furthermore, the methods may be a computer program realized by a computer, and may be a digital signal of the computer program.

Furthermore, the present invention may be a computer-readable recording medium apparatus such as a flexible disk, a hard disk, a CD-ROM (compact disk-read only memory), and MO (magneto-optical), a DVD-ROM (digital versatile disk-read only memory), a DVD RAM, or a semiconductor memory, that stores the computer program or the digital signal. Furthermore, the present invention may be the computer program or the digital signal recorded on any of the aforementioned recording medium apparatuses.

Furthermore, the present invention may be the computer program or the digital signal transmitted on a electric communication line, a wireless or wired communication line, or a network of which the Internet is representative.

Furthermore, the present invention may be a computer system that includes a microprocessor and a memory, the memory storing the computer program, and the microprocessor operating according to the computer program.

Furthermore, by transferring the program or the digital signal to the recording medium apparatus, or by transferring the program or the digital signal via a network or the like, the program or the digital signal may be executed by another independent computer system.

(10) The present invention may be any combination of the above-described embodiments and modifications.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A digital work protection system including a key management apparatus and a user apparatus, the key management apparatus generating and correlating device keys with nodes in a tree structure and assigning the user apparatus to the device keys, the key management apparatus comprising:
a determining unit operable to determine whether to add new leaves to the tree structure based on the number of leaves to which no user apparatus has been assigned;
an extending unit operable to, if the determining unit determines to add, generate new leaves to extend from one of the leaves to which no user apparatus has been assigned;
a user apparatus assigning unit operable to assign a user apparatus to one of the newly generated leaves;
a device key generating unit operable to generate and correlate new device keys with nodes with which no device key has been correlated, among all nodes from the one of the newly generated leaves to a root inclusive; and
a device key assigning unit operable to assign, to the user apparatus, device keys corresponding to the all nodes existing from the one of the newly generated leaves to the root inclusive, wherein
the user apparatus either encrypts a content using one of the assigned device keys and writes the encrypted content onto a recording medium or reads an encrypted content from the recording medium and decrypts the read content using the one of the assigned device keys.

2. A key management apparatus for generating and correlating device keys with nodes in a tree structure and assigning a user apparatus to the device keys, comprising:
a determining unit operable to determine whether to add new leaves to the tree structure based on the number of leaves to which no user apparatus has been assigned;
an extending unit operable to, if the determining unit determines to add, generate new leaves to extend from one of the leaves to which no user apparatus has been assigned;
a user apparatus assigning unit operable to assign a user apparatus to one of the newly generated leaves;
a device key generating unit operable to generate and correlate new device keys with nodes with which no device key has been correlated, among all nodes existing from the one of the newly generated leaves to a root inclusive; and
a device key assigning unit operable to assign, to the user apparatus, device keys corresponding to the all nodes existing from the one of the newly generated leaves to the root inclusive.

3. A key management apparatus for generating and correlating device keys with nodes in a tree structure and assigning a plurality of user apparatuses to the device keys, comprising:
a device key storage unit operable to store in advance the tree structure and device keys that have been assigned to user apparatuses correlated with some leaves in the tree structure;
a determining unit operable to determine whether to add new leaves to the tree structure based on the number of leaves to which no user apparatus has been assigned;
an extending unit operable to, if the determining unit determines to add, generate new leaves to extend from one of the leaves to which no user apparatus has been assigned;
a user apparatus assigning unit operable to assign a user apparatus to one of the newly generated leaves;
a device key generating unit operable to generate and correlate new device keys with nodes with which no device key has been correlated, among all nodes existing from the one of the newly generated leaves to a root inclusive; and
a device key assigning unit operable to assign, to the user apparatus, device keys corresponding to the all nodes existing from the one of the newly generated leaves to the root inclusive.

4. The key management apparatus of claim 3, wherein
the determining unit includes:
a counting unit operable to refer to the tree structure stored in the device key storage unit and count leaves to which no user apparatus is assigned; and
a comparison unit operable to compare the counted number of leaves with a threshold value, wherein
the determining unit determines to add new leaves to the tree structure if the counted number of leaves is equal to or smaller than the threshold value.

5. The key management apparatus of claim 4, wherein
the device key generating unit further generates and correlates new device keys with all roots of subtrees that are generated when the nodes existing from the leaf to the root inclusive are deleted from the tree structure, the key management apparatus further comprising:
an encrypted media key generating unit operable to generate encrypted media keys by encrypting media keys using all device keys generated by the device key generating unit on a one-to-one basis; and
an encrypted media key writing unit operable to write the generated encrypted media keys onto a recording medium.

6. The key management apparatus of claim 5, wherein
the comparison unit stores the threshold value in advance and compares the counted number of leaves with the threshold value.

7. The key management apparatus of claim 5, wherein
the device key storage unit stores the same number of pieces of node information as there are nodes in the tree structure, the pieces of node information being linked to each other in the same manner as the nodes in the tree structure, each piece of node information including node ID information for identifying a certain node, a device key corresponding to the certain node, and user apparatus ID information for identifying a user apparatus corresponding to the certain node,
the extending unit generates a new piece of node information that contains only node ID information identifying a new leaf, the new piece of node information linking to a piece of node information containing node ID information that identifies a leaf to which no user apparatus is assigned,
the user apparatus assigning unit adds user apparatus ID information to the new piece of node information, and
the device key generating unit adds a device key to the new piece of node information.

8. The key management apparatus of claim 5, wherein
the tree structure stored in the device key storage unit is an n-ary tree structure, wherein n is an integer no smaller than 2, and
the extending unit generates n new leaves extending from one leaf.

9. The key management apparatus of claim 5, wherein
the tree structure stored in the device key storage unit is an n-ary tree structure, wherein n is an integer no smaller than 2, and
the extending unit generates m new leaves extending from one leaf, wherein m is an integer satisfying m>n.

10. The key management apparatus of claim 9, wherein
the extending unit generates m new leaves extending from one leaf, wherein m=n+1.

11. The key management apparatus of claim 8, wherein
the extending unit generates n further-new leaves extending from each of then new leaves, resulting in generation of n² leaves.

12. A user apparatus for either encrypting a content using one of a plurality of device keys assigned by a key management apparatus, which has one or more device keys for each node existing from each leaf to a root inclusive, and writing the encrypted content onto a recording medium or reading an encrypted content from the recording medium and decrypting the read content using one of the assigned device keys, wherein
the key management apparatus (a) determines whether to add new leaves to the tree structure based on the number of leaves to which no user apparatus is assigned, (b) if it is determined to add, generates new leaves to extend from one of the leaves to which no user apparatus has been assigned, (c) assigns a user apparatus to one of the newly generated leaves, (d) generates and correlates new device keys with nodes with which no device key has been correlated, among all nodes existing from the one of the newly generated leaves to a root inclusive, and (e) assigns to the user apparatus all device keys corresponding to the nodes existing from the one of the newly generated leaves to the root inclusive,
the user apparatus comprising:
a media key identifying unit operable to identify an encrypted media key that was encrypted using one of the device keys assigned to the user apparatus, out of a plurality of encrypted media keys written on the recording medium;
a media key decrypting unit operable to restore a media key by decrypting the identified encrypted media key using the device key that was used for encrypting the media key; and
an encryption/decryption unit operable to either encrypt a content using the generated media key and write the encrypted content onto the recording medium or read an encrypted content from the recording medium and decrypt the read content using the generated media key.

13. A recording medium having recorded thereon:
encrypted media keys that are generated by encrypting media keys using device keys as encryption keys, wherein
the device keys are generated by a key management apparatus, and
the key management apparatus (a) determines whether to add new leaves to the tree structure based on the number of leaves to which no user apparatus is assigned, (b) if it is determined to add, generates new leaves to extend from one of the leaves to which no user apparatus has been assigned, (c) assigns a user apparatus to one of the newly generated leaves, (d) generates and correlates new device keys with nodes with which no device key has been correlated, among all nodes existing from the one of the newly generated leaves to a root inclusive, and (e) assigns to the user apparatus all device keys corresponding to the nodes existing from the one of the newly generated leaves to the root inclusive.

14. A key management method for use in a key management apparatus that generates and correlates device keys with nodes in a tree structure and assigns a plurality of user apparatuses to the device keys, wherein
the key management apparatus stores the tree structure and device keys that have been assigned to user apparatuses correlated with some leaves in the tree structure;
the key management method comprising:
a determining step for determining whether to add new leaves to the tree structure based on the number of leaves to which no user apparatus is assigned;
an extending step for, if the determining step determines to add, generating new leaves to extend from one of the leaves to which no user apparatus has been assigned;
a user apparatus assigning step assigning a user apparatus to one of the newly generated leaves;
a device key generating step for generating and correlating new device keys with nodes with which no device key has been correlated, among all nodes existing from the one of the newly generated leaves to a root inclusive; and
a device key assigning step for assigning to the user apparatus all device keys corresponding to the nodes existing from the one of the newly generated leaves to the root inclusive.

15. A key management program for use in a key management apparatus that generates and correlates device keys with nodes in a tree structure and assigns a plurality of user apparatuses to the device keys, wherein
the key management apparatus stores the tree structure and device keys that have been assigned to user apparatuses correlated with some leaves in the tree structure;
the key management program comprising:
a determining step for determining whether to add new leaves to the tree structure based on the number of leaves to which no user apparatus is assigned;
an extending step for, if the determining step determines to add, generating new leaves to extend from one of the leaves to which no user apparatus has been assigned;
a user apparatus assigning step assigning a user apparatus to one of the newly generated leaves;
a device key generating step for generating and correlating new device keys with nodes with which no device key has been correlated, among all nodes existing from the one of the newly generated leaves to a root inclusive; and
a device key assigning step for assigning to the user apparatus all device keys corresponding to the nodes existing from the one of the newly generated leaves to the root inclusive.

16. A computer-readable recording medium on which a key management program for use in a key management apparatus that generates and correlates device keys with nodes in a tree structure and assigns a plurality of user apparatuses to the device keys is recorded, wherein
the key management apparatus stores the tree structure and device keys that have been assigned to user apparatuses correlated with some leaves in the tree structure;
the key management program comprising:
a determining step for determining whether to add new leaves to the tree structure based on the number of leaves to which no user apparatus is assigned;
an extending step for, if the determining step determines to add, generating new leaves to extend from one of the leaves to which no user apparatus has been assigned;
a user apparatus assigning step assigning a user apparatus to one of the newly generated leaves;
a device key generating step for generating and correlating new device keys with nodes with which no device key has been correlated, among all nodes existing from the one of the newly generated leaves to a root inclusive; and
a device key assigning step for assigning to the user apparatus all device keys corresponding to the nodes existing from the one of the newly generated leaves to the root inclusive.
